(19) United States
(12) Patent Application Publication
(10) Pub. No.: US 2007/0272201 A1
(43) Pub. Date: Nov. 29, 2007

(54) Combustion Apparatus and Combustion Method

(75) Inventors: Shunsuke Amano, Kanagawa (JP); Masataka Arai, Gunma (JP)

Correspondence Address: OBLON, SPIVAK, MCCLELLAND MAIER & NEUSTADT, P.C., 1940 DUKE STREET, ALEXANDRIA, VA, 22314, US

(73) Assignee: EBARA CORPORATION, Ohta-ku (JP)

(21) Appl. No.: 10/588,004

(22) PCT Filed: Feb. 9, 2005
(86) PCT No.: PCT/JP05/02374

§ 371 Date: May 9, 2007

(30) Foreign Application Priority Data
Feb. 10, 2004 (JP) 2004-032933

(51) Int. Cl. F02B 17/00; F23C 7/00

(52) U.S. Cl. 123/295; 431/2

(57) ABSTRACT

A combustion apparatus according to the present invention can positively control and generate burnt gas recirculation with a simple structure. The combustion apparatus has a cylindrical container (12) having a combustion chamber, a close end (10), and an open end (26), an inflow passages (20) for supplying combustion air into the combustion chamber in the cylindrical container (12), and a fuel nozzle (18) for supplying fuel into the combustion chamber in the cylindrical container (12). A flow (28) of air is formed so as to have a velocity component in a direction of a central axis (J) from the open end (26) to the close end (10) and a velocity component to swirl in a circumferential direction of said annular container (12). Fuel is injected so as to have a velocity component in the direction of the central axis (J) from the close end (10) to the open end (26) and a velocity component directed radially outward.

### TECHNICAL FIELD

The present invention relates to a combustion apparatus and a combustion method, and more particularly to a combustion apparatus and a combustion method for supplying combustion air and fuel to a combustion chamber to mix and combust the combustion air and the fuel.

### BACKGROUND ART

Regulation regarding air pollutants discharged from a combustion apparatus, particularly nitrogen oxide (NOx), becomes stricter and stricter. Thus, there has been demanded technology to reduce discharge of NOx.

Nitrogen oxide (NOx) is generally classified according to its generation mechanism into three types: thermal NOx, prompt NOx, and fuel NOx. Thermal NOx is generated when nitrogen in air reacts with oxygen at a high temperature, and greatly depends on temperature. Prompt NOx is generated particularly in a flame of fuel-rich condition. Fuel NOx is generated while nitrogenous compounds contained in fuel are converted.

Recently, clean fuel including no nitrogenous compounds has been used in many cases. In such cases, fuel NOx is hardly generated. When a design of fuel-rich combustion is modified into a design of lean combustion in order to reduce prompt NOx, the generation of prompt NOx can be suppressed. As compared to the aforementioned reduction of fuel NOx and prompt NOx, reduction of thermal NOx is most difficult and is becoming a key of NOx reduction technology in recent years.

Here, it is important to lower a combustion temperature in order to reduce thermal NOx. Technology to lower a combustion temperature includes premixed combustion, particularly lean premixed combustion, pre-evaporation, rich and lean combustion, two-stage combustion, burnt gas recirculation, and the like.

In a case of gaseous fuel, a uniform distribution of fuel concentration can be achieved by premixed combustion in which fuel is sufficiently mixed with air, then ignited, and combusted, and a combustion temperature can be lowered particularly by premixed combustion in fuel-lean condition. However, premixed combustion has problems that a stable combustion range is so narrow that backfire or blow-off is likely to occur. Further, there is a defect that liquid fuel cannot be premixed unless the fuel has previously been evaporated (pre-evaporated).

In a case of liquid fuel, fuel to be injected is atomized when the fuel passes through nozzles having a small passage cross-section. Usually, droplets of the fuel remain at the time of ignition. Since combustion occurs while the droplets are being evaporated, a location with a theoretical air ratio is inevitably produced, and temperature locally increases. Thus, there is a limit to reduction of thermal NOx.

Pre-evaporation has been known as technology to solve the above problems. In pre-evaporation, a pre-evaporation portion is provided inside or outside of a combustor, and fuel is sprayed into the pre-evaporation portion, evaporated by heating from an external source, and then combusted. According to the pre-evaporation, thermal NOx reduction equivalent to that in the case of gaseous fuel can be expected. However, the size of the combustion apparatus problematically becomes large by the pre-evaporation portion.

Further, fuel or air is divided into several stages and supplied into a combustion apparatus so that air ratios are controlled at each region in a combustion chamber. In this case, a portion having a fuel concentration higher than a theoretical air ratio and a portion having a fuel concentration lower than the theoretical air ratio are intentionally formed so as to avoid a mixed state region with the theoretical air ratio, thereby reducing thermal NOx.

However, such technology has been employed in many large-sized combustion furnaces but cannot be applied to small-sized combustion apparatuses because a supply system of fuel or air becomes complicated. Further, it is difficult to find optimal supply locations of fuel or air and optimal division ratios, or to control these locations and division ratios according to loads.

Burnt gas recirculation is technology to achieve slow and uniform combustion by mixing a combustion gas having a high temperature and a low oxygen concentration with combustion air. Thus, a combustion temperature is lowered while an inert gas is increased so as to increase a heat capacity. An average flame temperature is lowered. Hence, thermal NOx is reduced. The burnt gas recirculation is applied mainly to a combustion apparatus in a boiler and an industrial furnace, and an engine.

Methods to produce burnt gas recirculation include use of a flame holder, external recirculation, and internal recirculation. Combustion methods called flue gas recirculation (FGR) or exhaust gas recirculation (EGR) have been known but are basically the same technology as the burnt gas recirculation.

For example, Japanese laid-open patent publication No. 2002-364812 discloses an example using burnt gas recirculation for gaseous fuel. Japanese patent No. 3139978 discloses an example using burnt gas recirculation for premixed combustion of gaseous fuel. In either case, a combustion gas is recirculated in a recirculation region formed centrally downstream of a flame holding plate and in a space between a combustion apparatus projecting in a combustion chamber and a combustion chamber wall.

However, a burnt gas recirculation flow centrally downstream of the flame holding plate does not reach a portion in which fuel is mixed with air before ignition. The burnt gas recirculation flow serves merely to stabilize ignition. Actually, a burnt gas recirculation flow from the space between the combustion apparatus and the combustion chamber wall is circulated only near the combustion apparatus. Accordingly, a combustion gas that has been sufficiently combusted so as to have a high temperature and a low oxygen concentration is not recirculated, and the amount of circulation is small. Thus, reduction effect of thermal NOx becomes small.

Further, in these combustion apparatuses, the size of the combustion chamber must be sufficiently larger than the diameter of the combustion apparatus in order to draw a burnt gas recirculation flow from the outside of the combustion apparatus in a direction of a central axis. Accordingly, this technology is not suited for purposes of a combustion apparatus of a gas turbine or the like where the size of a combustion chamber should be made as small as possible. Further, it is difficult to apply this technology to liquid fuel.

For example, Japanese laid-open patent publication No. 9-133310 discloses technology regarding gaseous fuel to recirculate a combustion gas from a rear central portion of a flame holding plate by the flame holding plate, produce a lifted and divided flame, and recirculate a combustion gas from a lateral portion of the flame. According to this technology the amount of burnt gas recirculation can be increased. However, a structure of a burner becomes complicated due to the divided flame. A cross-section of the burner includes a portion having no flame. Accordingly, the size of the burner problematically becomes large (a combustion load per volume is low). Further, it is difficult to apply this technology to liquid fuel.

For example, in a combustion apparatus using premixed combustion of gaseous fuel for a boiler disclosed in Japanese laid-open patent publication 11-153306, a plurality of premixed gas injection holes are provided in a combustion chamber wall, and a premixed gas is injected as a combustion gas toward an adjacent premixed gas injection hole. However, since fuel and air have previously been mixed, fresh air is involved in combustion at the time of ignition and mixed with a combustion gas only after starting combustion. Accordingly, there is a problem that effect to make combustion slow is small. Further, this technology relates to premixed combustion for gaseous fuel. A premixed gas reaches a next injection hole in a short period of time. It is difficult to apply this technology to liquid fuel.

For example, in a burner for a boiler disclosed in Japanese patent No. 3171147, a low-pressure portion is formed by kinetic energy of combustion air flowing around a fuel nozzle, mainly with respect to liquid fuel. A combustion gas in a furnace is drawn and mixed with the combustion air. However, since the combustion gas is mixed outside of the combustion air, the combustion gas is hardly mixed inside of the combustion air. Fuel is first mixed with the combustion air and then gradually mixed with the combustion gas. Accordingly, a combustion phenomenon depends on combustion air having the same oxygen concentration as usual, and hence slow ignition and combustion under a low oxygen concentration cannot be achieved sufficiently. Further, a structure for drawing a combustion gas is complicated. Furthermore, since a divided flame is employed, the burner has a complicated structure. A cross-section of the burner includes a portion having no flame. Accordingly, the size of the burner problematically becomes large (a combustion load per volume is low).

For example, Japanese patent publication No. 2000-179837 discloses technology in which a swirling flow is induced in a cylindrical combustion apparatus so that static pressure is lowered at a central portion of the swirling flow to thereby draw another gas from a normal direction of a swirling surface into a swirling center. This technology is applied to burnt gas recirculation at a secondary combustion zone in a cylindrical combustion apparatus. Not only supply of primary air and secondary air for combustion, but also supply of fuel serve to induce a swirling flow. However, effect of recirculation of the combustion gas introduced by the swirling flow is limited to combustion control at a secondary combustion zone. A region of a high fuel concentration near a flame is not a targeted region of the burnt gas recirculation Accordingly, NOx reduction effect is limited only to temperature control at an end portion of flame.

Next, a specific arrangement of a conventional combustion apparatus and problems of the conventional combustion apparatus will be described in greater detail with reference to FIGS. 1 through 3.

FIG. 1 shows an example of a conventional general combustion apparatus. The combustion apparatus shown in FIG, 1 is a cylindrical combustion apparatus and has a cylindrical container 2001, an inflow casing 2002, a swirler 2003, a partition cylinder 2004, a fuel nozzle 2005, and a flame holding plate 2006 disposed downstream of the fuel nozzle 2005 and coaxially with the fuel nozzle 2005. Inflow passages are formed by the cylindrical container 2001, the inflow casing 2002, the swirler 2003, and the partition cylinder 2004.

Combustion air 2010 flows into the inflow casing 2002, flows through a space 2012 between the partition cylinder 2004 and the fuel nozzle 2005, and then flows near the flame holding plate 2006 into the cylindrical container 2001 by a blower or a compressor (not shown). The combustion air 2010 flowing into the inflow casing 2002 flows through the swirler 2003 into the cylindrical container 2001.

On the other hand, fuel 2014 is injected through the fuel nozzle 2005 into the cylindrical container 2001 by a fuel pump, a blower, or a compressor (not shown). The fuel 2014 is mixed with the combustion air 2010 and combusted to produce a combustion gas 2016. The produced combustion gas 2016 flows out of an open end 2007 of the cylindrical container 2001.

Here, each of the flame holding plate 2006 and the swirler 2003 allows stable ignition. Either one of these is used in most cases. In the example shown in FIG. 1, the flame holding plate 2006 is in the form of a cone having a larger diameter near the open end 2007. The flame holding plate 2006 blocks a flow of air flowing through the space 2012 between the partition cylinder 2004 and the fuel nozzle 2005, reduces a velocity of flow of the combustion air 2010 at a tip of the fuel nozzle 2005, and forms a flow region 2018, in which air flows backward from a downstream region, at a downstream side of the flame holding plate 2006. The swirler 2003 swirls a flow of the combustion air 2010 and forms a negative pressure region at the center of the swirling flow to thereby form a flow region 2019, in which air flows backward from a downstream region. The back flows 2018 and 2019 return a combustion gas 2016 having a high temperature to an ignition region right downstream of the tip of the fuel nozzle 2005.

However, the back flow of the combustion gas is present only at an inner side of a fuel track 2014 but does not reach a portion at which the fuel 2014 is mixed with the air 2010. Accordingly, a function of the back flow of the combustion gas is merely to stabilize ignition. The swirler 2003 also has a function of promoting mixing of the fuel 2014 and the combustion air 2010.

An arrangement, effects, and problems of a conventional combustion apparatus which utilizes burnt gas recirculation will be described with reference to FIG. 2. A combustion apparatus shown in FIG. 2 is a cylindrical combustion apparatus, which is applied to boilers or industrial furnaces. The combustion apparatus has a second swirler 2030 disposed outside of a container 2001 and an outer cylinder 2031 in addition to the arrangement of the conventional combustion apparatus shown in FIG. 1

Operations of the combustion apparatus shown in FIG. 2 will be described. When the second swirler 2030 is located away from a combustion chamber wall 2032, the combustion gas 2016 in a combustion chamber is drawn through the second swirler 2030 by induction effect of the flowing combustion air 2010, mixed with the combustion air 2010, and combusted.

This is a typical example of conventional technology which utilizes burnt gas recirculation. Since the combustion gas 2016 is introduced from an outside of the swirling flow of the combustion air 2010, the combustion gas 2016 is hardly mixed inside of the combustion air 2010. The fuel 2014 is first mixed with the combustion air 2010 and gradually mixed with the combustion gas 2016. Accordingly, combustion phenomenon depends on the combustion air 2010 having the same oxygen concentration as usual, and hence ignition and combustion under a low oxygen concentration cannot be achieved.

Further, in the combustion apparatus shown in FIG. 2, since a burnt gas recirculation flow is drawn from an outside of the outer cylinder 2031, the size of the combustion chamber must be sufficiently larger than the diameter of the outer cylinder 2031. Accordingly, this combustion apparatus is not suited for purposes of a combustion apparatus of a gas turbine or the like where the size of the combustion chamber should be made as small as possible.

An arrangement, effects, and problems of a conventional cylindrical gas turbine combustion apparatus will be described with reference to FIG. 3. A conventional combustion apparatus of a gas turbine has a extremely low total air ratio because a targeted temperature is considerably lower than a flame temperature in combustion with a theoretical amount of air, i.e., just the amount of air containing oxygen required for combustion of fuel. When general hydrocarbon fuel is used, it is difficult to combust the fuel by a single stage.

For this reason, supply of the combustion air is divided into several stages. First, fuel is mixed with only a portion of the combustion air (primary air 2040) and combusted. Then, the rest of the combustion air is added. Thus complete combustion is achieved under a desired outlet temperature.

The container 2001a is completely enclosed by the inflow casing 2002a and generally fixed at the vicinity of the fuel nozzle 2005 and the outlet of the container 2001a. Since combustion is performed inside of the container 2001a, the container 2001a has a sufficiently high temperature even if an outer surface of the container 2001a is cooled by the combustion air 2010. The container 2001a is expanded in an axial direction of the container 2001a by thermal expansion. Thus, the container 2001a should be fixed to the inflow casing 2002a by a structure capable of absorbing thermal expansion.

Further, the fuel nozzle 2005 and an ignition device (not shown) should be attached to the container 2001a so as to extend through the inflow casing 2002a. Thus, a structure capable of absorbing thermal expansion and extending through the inflow casing 2002a is needed. Such a structure is complicated and increases cost.

A region from a location at which combustion air of the first stage is mixed with fuel in the container 2001a to air inflow portions of the second stage is referred to as a primary combustion zone 2042. With regard to combustion in a gas turbine, many technical ideas to add air downstream of the primary combustion zone 2042 have been known to prevent a lowered combustion efficiency, discharge of unburnt components, and increase of NOx.

In FIG. 3, the reference numeral 2044 represents air holes formed in the container 2001a, and the reference numeral 2046 represents secondary and dilution air flowing from the air holes 2044 into the container 2001a.

As described above, combustion under a low oxygen concentration by burnt gas recirculation has been known as an effective method for reducing thermal NOx. However, there are no conventional combustion apparatuses, directed to combustion under a low oxygen concentration by burnt gas recirculation, which have a sufficient amount of burnt gas recirculation or NOx reduction effects and there are no conventional combustion apparatuses which can achieve pre-evaporation combustion even with liquid fuel and premixed combustion as with gaseous fuel.

### DISCLOSURE OF INVENTION

The present invention has been proposed in view of the above drawbacks of the conventional technology. It is, therefore, an object of the present invention to provide a combustion apparatus and a combustion method which can maximize effects of burnt gas recirculation, can achieve pre-evaporation in a case of liquid fuel, premixed combustion in a case of gaseous fuel/liquid fuel, and slow combustion under a low oxygen concentration, and can suppress generation of NOx with a simple structure.

Further, another object of the present invention is to provide a combustion apparatus suitable for inexpensively achieving use of ceramics to improve high-temperature resistance, particularly a combustion apparatus which can simplify a structure and reduce cost when applied to a gas turbine combustion apparatus.

According to a first aspect of the present invention, there is provided a combustion apparatus which can positively control and generate burnt gas recirculation with a simple structure. The combustion apparatus has a cylindrical combustion chamber; an air supply portion for supplying combustion air into the combustion chamber; and a fuel supply portion for supplying fuel into the combustion chamber. The combustion apparatus is configured so that a flow of the combustion air supplied into the combustion chamber first crosses a track of the fuel supplied into the combustion chamber at a region away from the fuel supply portion and then crosses the track of the supplied fuel again at a region near the fuel supply portion.

In this case, it is desirable that the fuel supply portion is configured so as to form a flow of the fuel with a velocity component in a direction of a central axis of the combustion chamber and a velocity component in a direction from the central axis of the combustion chamber to a wall surface of the combustion chamber. It is desirable that the air supply portion is configured so as to form a flow of the combustion air with a velocity component in a direction opposed to the direction of the fuel with respect to the direction of the central axis of the combustion chamber and a velocity component to swirl in a circumferential direction. Further it is desirable that the flow of the fuel has a velocity component in the direction of an outlet of the combustion apparatus while the flow of the combustion air has a velocity component in a direction opposite to the direction of the outlet.

According to a second aspect of the present invention, there is provided a combustion apparatus which can positively control and generate burnt gas recirculation with a simple structure. The combustion apparatus has a cylindrical container having a close end and an open end; an inflow passage for supplying combustion air into a combustion chamber in the cylindrical container the inflow passage being formed at a location away from the close end in a direction of a central axis of the cylindrical container so as to extend through a side surface of the cylindrical container; and a fuel nozzle provided inside of the close end of the cylindrical container for supplying fuel into the combustion chamber in the cylindrical container. The inflow passage is configured so as to form a flow of the air with a velocity component in the direction of the central axis of the cylindrical container from the open end to the close end and a velocity component to swirl in a circumferential direction of the cylindrical container. The fuel nozzle is configured so as to inject the fuel toward the inflow passage with a velocity component in the direction of the central axis of the cylindrical container from the close end to the open end and a velocity component directed radially outward.

According to a third aspect of the present invention, there is provided a combustion apparatus which can positively control and generate burnt gas recirculation with a simple structure. The combustion apparatus has a cylindrical container having a close end and an open end; an inflow passage for supplying combustion air into a combustion chamber in the cylindrical container; and a fuel nozzle for supplying fuel into the combustion chamber in the cylindrical container. The cylindrical container has a portion having a reduced diameter at a location away from the close end along a central axis of the cylindrical container by a predetermined distance. The inflow passage is formed at the portion having a reduced diameter in the cylindrical container and is configured so as to form a flow of the air with a velocity component in the direction of the central axis of the cylindrical container from the open end to the close end and a velocity component to swirl in a circumferential direction of the cylindrical container. The fuel nozzle is configured so as to inject the fuel toward the inflow passage with a velocity component in the direction of the central axis of the cylindrical container from the close end to the open end (a velocity component in a direction opposed to a direction of the flow of the air) and a velocity component directed radially outward (a velocity component having a radially outward divergence angle).

According to a fourth aspect of the present invention, there is provided a combustion apparatus which can positively control and generate burnt gas recirculation with a simple structure. The combustion apparatus has a cylindrical container having a close end and an open end; a cylindrical member (secondary cylinder) disposed substantially coaxially with a central axis of the cylindrical container and positioned on the open end side the cylindrical member having a diameter smaller than that of the cylindrical container; an annular connecting member connecting the open end of the cylindrical container and an outer circumferential surface of the cylindrical member to each other; an inflow passage formed in the connecting member for supplying combustion air into the combustion chamber in the cylindrical container, and a fuel nozzle provided inside of the close end of the cylindrical container for supplying fuel into the combustion chamber in the cylindrical container. The inflow passage is configured so as to form a flow of the air with a velocity component in the direction of the central axis of the cylindrical container from the open end to the close end and a velocity component to swirl in a circumferential direction of the cylindrical container. The fuel nozzle is configured so as to inject the fuel toward the inflow passage with a velocity component in the direction of the central axis of the cylindrical container from the close end to the open end (a velocity component in a direction opposed to a direction of the flow of the air) and a velocity component directed radially outward.

A second inflow passage may be provided on a side surface of the cylindrical container near the close end for supplying air inwardly in a radial direction of the cylindrical container.

A flow adjusting structure may be provided on the close end within the cylindrical container and/or on a side wall near the close end for suppressing a flow of the air swirling in a circumferential direction of the cylindrical container with a velocity component in the central axis of the cylindrical container from the open end to the close end in a region near the close end.

A flow adjusting structure may be provided on the close end within the cylindrical container and/or on a side wall of the cylindrical container near the close end for converting a flow of air having a velocity component in a direction of the central axis of the cylindrical container from the open end to the close end and swirling in a circumferential direction of the cylindrical container into a flow directed inwardly in a radial direction near the close end.

An additional fuel nozzle may be provided at a location closer to the close end than the inflow passage with respect to the direction of the central axis of the cylindrical container.

According to a fourth aspect of the present invention, there is provided a combustion method which can positively control and generate burnt gas recirculation with a simple structure. According to the combustion method, combustion air and fuel are supplied into a combustion chamber in a combustion apparatus and mixed and combusted therein. A track of an air flow and a track of a fuel flow are not the same in the combustion chamber. The track of the air flow first crosses the track of the fuel flow at a region near a tip of the track of the fuel flow and then crosses the track of the fuel flow again at a region from a root of the track of the fuel flow to a vicinity of the tip.

It is desirable that the fuel flow has a velocity component in a direction of a central axis of the combustion chamber and a velocity component in a direction from the central axis of the combustion chamber to a wall surface of the combustion chamber. It is desirable that the air flow has a velocity component in a direction opposed to the direction of the fuel with respect to the direction of the central axis of the combustion chamber and a velocity component to swirl in a circumferential direction.

According to the present invention, a track of an air flow and a track of a fuel flow are not the same in said combustion chamber. The track of the air flow and the track of the fuel flow cross two times. The track of the air flow first crosses the track of the fuel flow at a region near a tip of the track of the fuel flow and then crosses the track of the fuel flow again at a region from a root of the track of the fuel flow to a vicinity of the tip. Accordingly, it is possible to positively control and generate burnt gas recirculation with a simple structure.

Thus, when the present invention is applied to a general combustion apparatus, it is possible to enhance the stability and maximize effects of burnt gas recirculation.

Since effects of burnt gas recirculation can be maximized with high stability, it is possible to perform combustion with a combustion gas having a high temperature and a low oxygen concentration. Accordingly it is possible to achieve pre-evaporation combustion having stable evaporation characteristics in a case of liquid fuel, in which it has been difficult to reduce NOx with the conventional technology, premixed combustion in either case of gaseous fuel or liquid fuel, slow combustion, uniform combustion with a low maximum flame temperature, and combustion with a low average flame temperature due to the heat capacity of an inert gas in the combustion gas. Therefore, it is possible to suppress thermal NOx, which has been difficult to suppress with the conventional technology.

Here, in the combustion chamber, the track of the air and the track of the fuel are not the same, and the track of the air and the track of the fuel intersect each other two times. The track of the air flow first crosses a track of the fuel flow near a tip of the fuel track and then crosses the track of the fuel flow again at a region from a root of the track of the fuel flow to the vicinity of the tip. In order to meet the above requirements, for example, the air flow and the fuel flow are opposed in a state such that the air flows in an opposite direction of the outlet direction while the fuel flows in the outlet direction, and the fuel spreads outwardly in a direction perpendicular to the central axis of the combustion chamber (outwardly in a radial direction in a case of a cylindrical container) as the fuel is farther from an injection side.

Here, according to the present invention, the fuel flow has a velocity component in the direction of the central axis of the combustion chamber and a velocity component directed from the central axis of the combustion chamber toward a wall surface of the combustion chamber. The air flow has a velocity component in an opposite direction of the central axis of the combustion chamber and a velocity component to swirl in a circumferential direction. The flow of the fuel has a velocity component in the direction of the outlet of the combustion apparatus, and the flow of the combustion air has a velocity component in an opposite direction to the direction of the outlet. Accordingly, the aforementioned flows can be achieved.

According to the present invention, a portion of the flow of the air supplied from the air supply means (inflow passage) into the combustion chamber flows as a combustion gas having a low temperature or an air flow not being a combustion gas along an inner wall surface of the combustion chamber. As a result, the inner wall of the combustion apparatus is protected from heat in the combustion apparatus by the combustion gas having a low temperature or the air flow not being a combustion gas. Consequently, it is possible to provide a combustion apparatus having a high durability to combustion heat.

As described above, according to the present invention, it is possible to provide a simple structure which can positively control and generate burnt gas recirculation. Accordingly, it is possible to provide a combustion apparatus which can readily use a heat resistant material such as ceramics, can facilitate disassembly and part replacement, and has easiness of maintenance.

When an auxiliary fuel nozzle (additional fuel nozzle) is provided, it is possible to provide a combustion apparatus which can suppress generation of thermal NOx in multi fuel combustion of gaseous fuel/liquid fuel and combustion with fuel or a waste liquid having a low heating value.

When the present invention having the above arrangement is applied to a primary combustion zone of a gas turbine combustion apparatus, it is possible to positively control and generate burnt gas recirculation with a simple structure. Thus, the stability can be enhanced in the primary combustion zone of the gas turbine combustion apparatus, and effects of burnt gas recirculation can be maximized.

In the gas turbine combustion apparatus to which the present invention is applied, the primary combustion zone can be designed to be leaner because of high stability. Accordingly, it is possible to lower an average combustion temperature so as to further suppress generation of thermal NOx.

Further, in the gas turbine combustion apparatus to which the combustion apparatus of the present invention is applied, it is possible to enhance the stability and maximize effects of burnt gas recirculation. Accordingly, it is possible to suppress generation of thermal NOx in a case of liquid fuel, in which it has been difficult to reduce NOx with the conventional technology.

As described above, in the combustion apparatus of the present invention, since an inner wall of the combustion apparatus is suitably cooled by an air flow having a low temperature, it is possible to provide a gas turbine combustion apparatus having a high durability.

Further, in the combustion apparatus of the present invention, because of a simple structure, it is possible to provide a gas turbine combustion apparatus which can readily use a heat resistant material such as ceramics, facilitate disassembly and replacement, and has easiness of maintenance.

Additionally, in a gas turbine to which a combustion apparatus of the present invention is applied, since a liner can be exposed while no air flows outside of the primary combustion zone, a fuel nozzle and an ignition device can be disposed with a simple structure, so that cost can be reduced.

Further, since thermal expansion of the liner can be reduced with respect to the casing, the structure can be simplified. Accordingly, it is possible to further reduce cost.

According to a gas turbine to which a combustion apparatus having an auxiliary fuel nozzle (additional fuel nozzle) of the present invention is applied, it is possible to suppress generation of thermal NOx in multi fuel combustion of gaseous fuel/liquid fuel and combustion with fuel or a waste liquid having a low heating value.

### BRIEF DESCRIPTION OF DRAWINGS

FIG. 1 is a cross-sectional view showing a conventional cylindrical combustion apparatus;

FIG. 2 is a cross-sectional view showing another example of a conventional cylindrical combustion apparatus;

FIG. 3 is a cross-sectional view showing a conventional cylindrical combustion apparatus for a gas turbine;

FIG. 4 is a perspective view showing a combustion apparatus according to a first embodiment of the present invention;

FIG. 5 is a cross-sectional view of FIG. 4;

FIG. 6 is a perspective view showing a combustion apparatus according to a second embodiment of the present invention;

FIG. 7 is a cross-sectional view of FIG. 6;

FIG. 8 is a perspective view showing a combustion apparatus according to a third embodiment of the present invention;

FIG. 9 is a cross-sectional view of FIG. 8;

FIG. 10 is a perspective view showing an example of a swirler in the embodiments of the present invention;

FIG. 11 is a perspective view showing another example of a swirler in the embodiments of the present invention;

FIG. 12 is a perspective view showing another example of a swirler in the embodiments of the present invention;

FIG. 13 is a perspective view showing another example of a fuel nozzle in the embodiments of the present invention;

FIG. 14 is a cross-sectional view of FIG. 13;

FIG. 15 is a perspective view showing another example of a fuel nozzle in the embodiments of the present invention;

FIG. 16 is a cross-sectional view of FIG. 15;

FIG. 17 is a perspective view showing an effect of the embodiments of the present invention;

FIG. 18A is a cross-sectional view of FIG. 17;

FIG. 18B is an enlarged view of FIG. 18A;

FIG. 19 is a cross-sectional view showing a combustion apparatus according to a fourth embodiment of the present invention;

FIG. 20 is a cross-sectional view showing a combustion apparatus according to a fifth embodiment of the present invention;

FIG. 21 is a perspective view showing a combustion apparatus according to a sixth embodiment of the present invention;

FIG. 22 is a perspective view showing a combustion apparatus according to a seventh embodiment of the present invention;

FIG. 23 is a perspective view showing a combustion apparatus according to an eighth embodiment of the present invention;

FIG. 24 is a perspective view showing a combustion apparatus according to a ninth embodiment of the present invention;

FIG. 25 is a perspective view showing a combustion apparatus according to a tenth embodiment of the present invention;

FIG. 26 is a perspective view showing a combustion apparatus according to an eleventh embodiment of the present invention;

FIG. 27 is a cross-sectional view showing a combustion apparatus according to a twelfth embodiment of the present invention;

FIG. 28 is a perspective view showing a combustion apparatus according to a thirteenth embodiment of the present invention;

FIG. 29 is a cross-sectional view of FIG. 28;

FIG. 30 is a cross-sectional view showing a combustion apparatus according to a fourteenth embodiment of the present invention;

FIG. 31 is a cross-sectional view showing a combustion apparatus according to a fifteenth embodiment of the present invention;

FIG. 32 is a cross-sectional view showing a combustion apparatus according to a sixteenth embodiment of the present invention;

FIG. 33 is a perspective view showing a combustion apparatus according to a seventeenth embodiment of the present invention;

FIG. 34 is a perspective view showing a case where a swirler is not used in the combustion apparatus of the second embodiment of the present invention;

FIG. 35 is a cross-sectional view of FIG. 34; and

FIG. 36 is a block diagram showing a case where a combustion apparatus according to the present invention is applied to a gas turbine generator.

### BEST MODE FOR CARRYING OUT THE INVENTION

A combustion apparatus according to embodiments of the present invention will be described below with reference to FIGS. 4 through 36. In the following embodiments, the same parts are denoted by the same reference numerals and will not be described below repetitively.

First, a combustion apparatus according to a first embodiment will be described with reference to FIGS. 4 and 5. The combustion apparatus shown in FIGS. 4 and 5 can be applied to general use mainly in boilers and industrial furnaces, and also in gas turbines. The combustion apparatus has an cylindrical container (hereinafter, simply referred to as a container) 12 with one end (close end) 10 which is closed, an inflow casing 14, a swirler 16, and a fuel nozzle 18 provided so as to extend through the upper end (close end) 10 of the container 12. A plurality of air inflow portions 20 are formed at common pitches on a side surface 13 of the container 12. Combustion air 22 flows through the air inflow portions 20 into the interior of the container 12, and inflow passages are formed by the air inflow portions 20, the inflow casing 14, and the swirler 16. The swirler 16, details of which will be described later, is formed so as to surround a perimeter of the side surface 13 of the container 12 including the air inflow portions 20.

As shown in FIGS. 4 and 5, combustion air 22 flows into the inflow casing 14 and then flows through the swirler 16 from the air inflow portions 20 into the container 12 by a blower or a compressor (not shown). Fuel is injected through the fuel nozzle 18 into the interior of the container 12 within a range of an angle α with respect to a central axis J (tracks shown by the reference numeral 23 in the drawing) by a fuel pump, a blower, or a compressor (not shown). The fuel 23 and the combustion air 22 are mixed and combusted, and a combustion gas 24 is discharged from the open end 26 of the container 12.

The combustion apparatus in the first embodiment has the following features. As shown in FIG. 5, the combustion air 22 flows into the container 12 from positions which are located away from the close end 10 of the container 12 in a direction of an axis J of the container 12 by a predetermined distance with a velocity component in a direction opposite to a direction from the close end 10 to the open end 26 of the container 12 (outlet direction), and forms a swirling flow 28. (Specifically, the combustion air 22 forms a flow having a velocity component in the direction of the central axis J of the cylindrical container 12 from the open end 26 to the close end 10 and a velocity component to swirl in a circumferential direction.) Further, the fuel is injected toward the inflow portions 20 for the combustion air in a direction from the close end 10 to the outlet 26 of the container 12 with a divergence angle a with respect to the central axis J of the container 12 in a radial direction. (The fuel is injected toward the air inflow portions 20 with a velocity component in the direction of the central axis J from the close end 10 to the open end 26 and a velocity component directed radially outward: the tracks shown by the reference numeral 23.)

Although not shown in the drawings, an opening ratio, shapes, and pitches of the air inflow portions 20 in the side surface of the container 12 can be set arbitrarily. Further, although not shown in the drawings, a structure to deflect the flowing combustion air 22 may be provided on the inflow portions 20 for the combustion air 22 flowing into the container 12 as long as the flowing combustion air 22 has a velocity component in a direction opposite to the outlet 26. Most typically, injection 23 of the fuel with a divergence angle with respect to the central axis of the container 12 can be achieved by a spiral-type nozzle.

In FIG. 5, the reference numeral 28 represents a swirling flow having a large velocity component in a direction opposite to the outlet 26, which is formed by the combustion air 22 flowing from the air inflow portions 20 and a combustion gas produced by combustion of mixture of the combustion air 22 and the fuel.

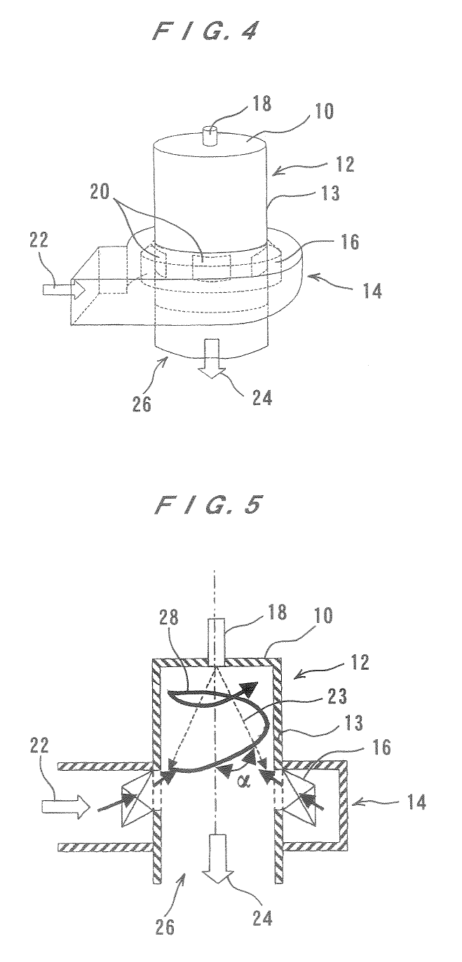

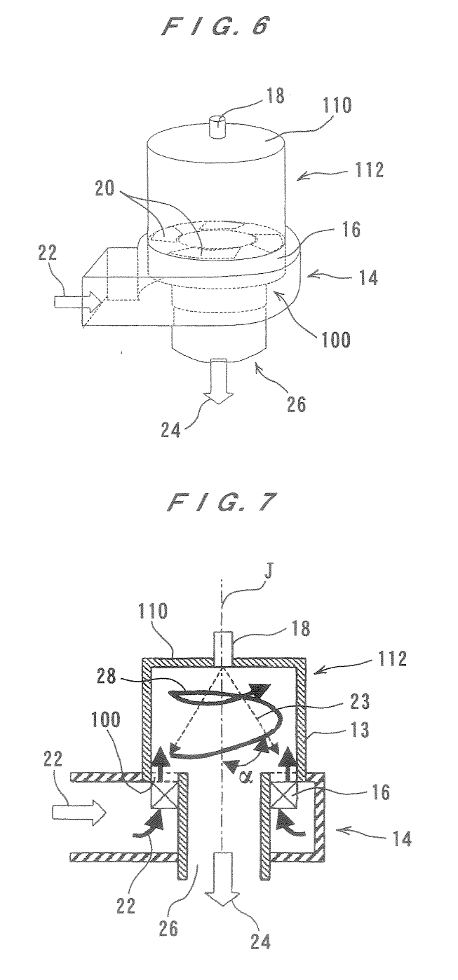

Next, a combustion apparatus according to a second embodiment will be described with reference to FIGS. 6 and 7. In the combustion apparatus shown in FIGS. 6 and 7, the container 12 in the first embodiment shown in FIGS. 4 and 5 is replaced with a container 112 which has a cross-section constricted at combustion air inflow portions.

Specifically, a stepped portion 100 having a discontinuously varying cross-section is formed substantially at the center of the cylindrical container 112 in a vertical direction of FIG. 7. Air inflow portions 20 for introducing combustion air 22 into the container 112 are formed at the stepped portion 100. In FIGS. 6 and 7, the reference numeral 110 represents a close end of the container 112.

In the combustion apparatus thus constructed according to the second embodiment, combustion air 22 flowing through an inflow casing 14 flows into a swirler 16 and through the air inflow portions 20 into the container 112 upward in FIG. 7. By the swirler, details of which will be described later, the air 22 flowing into the container 112 forms a swirling flow 28 having a larger velocity component in a direction opposite to an outlet 26. Specifically, the air 22 forms a flow 28 having a velocity component in a direction of a central axis J of the cylindrical container 112 from the open end 26 to a close end 110 and a velocity component to swirl in a circumferential direction. Fuel is injected toward the air inflow portions (inflow passages) 20 with a velocity component in the direction of the central axis J from the close end 10 to the open end 26 and a velocity component directed radially outward.

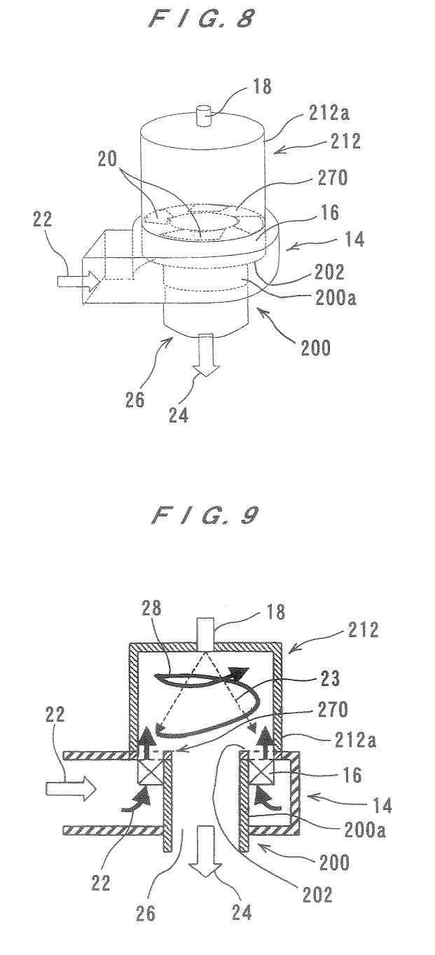

The swirler 16 and the inflow casing 14 are substantially the same as those in a third embodiment described later with reference to FIGS. 8 and 9. Accordingly, details of the swirler 16 and the inflow casing 14 will be described in the third embodiment.

In FIGS. 6 and 7, the stepped portion 100 of the cross-section change portion of the container is illustrated as being perpendicular to the direction of the central axis J of the container 112. However, the stepped portion 100 can have any desired angle. Further, although not shown in the drawings, an opening ratio, shapes, and pitches of the air inflow portions 20 can be set arbitrarily. Furthermore, the swirler 16 is illustrated as having an axial flow shape. However, the swirler 16 may have a mixed flow shape in which combustion air 22 also flows from a periphery of the swirler. Further, although not shown in the drawings, a structure to deflect the flowing combustion air 22 in a radial direction may be provided on the air inflow portions 20.

Next, a combustion apparatus according to a third embodiment of the present invention will be described with reference to FIGS. 8 and 9. In the combustion apparatus of the third embodiment shown in FIGS. 8 and 9, the container 12 in the first embodiment shown in FIGS. 4 and 5 is replaced with a structure divided into a container 212, a secondary cylinder 200, and a connecting member 270 at a cross-section change portion (stepped portion) 202 according to manufacturing requirements.

In FIGS. 8 and 9, the connecting member 270 is illustrated as being perpendicular to an axial direction of the container 212 and the secondary cylinder 200. However, the connecting member 270 can have any desired angle. Further, although not shown in the drawings, an opening ratio, shapes, and pitches of air inflow portions 20, which are provided in an annular gap between a side surface 212a of the container 212 and an outer circumferential side surface 200a of the secondary cylinder 200, can be set arbitrarily. Furthermore, a swirler 16 is illustrated as having an axial flow shape. However, the swirler 16 may have a mixed flow shape in which combustion air 22 also flows from a periphery of the swirler 16. Further, although not shown in the drawings, a structure to deflect the flowing combustion air 22 in a radial direction may be provided on the air inflow portions 20.

In the first embodiment to the third embodiment, each of the containers 12, 112, and 212 have a circular cross-sectional shape. However, the shapes of the containers 12, 112, and 212 may be changed into desired ones. The containers may be polygonal as long as a swirling flow is formed in the entire containers. Further, the cross-sectional shape of the container 12 may be varied in the axial direction at locations other than a combustion air inflow location. The aforementioned equivalent structures of the container can similarly be applied to all of the following embodiments. The structure of the swirler 16 forming inflow passages can be changed in various manners.

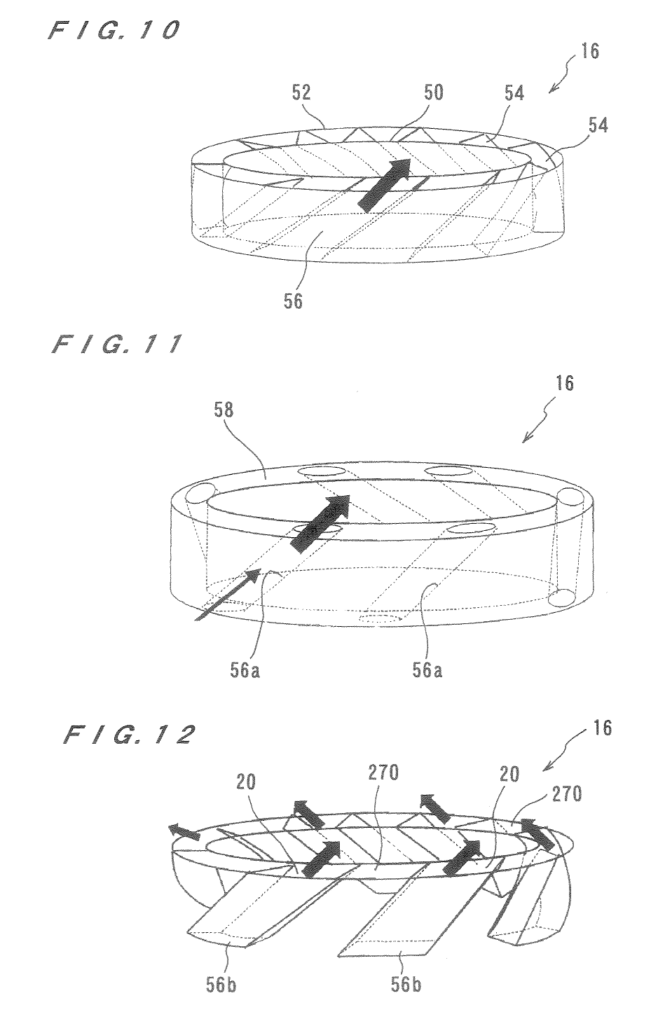

In the example of the third embodiment shown in FIGS. 8 and 9, the swirler 16 will be described in detail with reference to FIGS. 10 to 12. As shown in FIG. 10, the swirler 16 is generally configured such that swirl vanes 54 for defecting a flow are disposed between the inner cylinder 50 and the outer cylinder 52 to form air introduction passages 56. Further, as shown in another example of FIG, 11, the swirler 16 may have a plurality of air introduction passages 56a opened in an annular member 58 for deflecting a flow. In this case, the shape, the opening area, and the number of the air introduction passages 56a may be set arbitrarily. Alternatively, as shown in still another example of FIG. 12 which achieves the same effects as the above swirler 16, air introduction passages 56b divided for each air inflow portion 20 in the connecting member 270 may be attached to the connecting member 270.

Further, in a structure shown in FIGS. 10 and 11, the swirler 16 may also serve as a connecting member. Specifically, in the example shown in FIG. 10, the inner cylinder 50 and the outer cylinder 52 may be dispensed with. The secondary cylinder 200 (see FIGS. 9 and 10) and the container 212 (see FIGS. 8 and 9) may be connected to each other by swirl vanes 54. In this case, the swirl vanes 54 can also serve as a connecting member 270. In the example shown in FIG. 11, the annular member 58 can also serve as a connecting member 270. The aforementioned equivalent structures of the swirler 16 can similarly be applied to the first and second embodiments and all of the following embodiments of a combustion apparatus.

With regard to the casing, the shape of the inflow casing 14 may be changed arbitrarily in the first to third embodiments. For example, although not shown in the drawings, the inflow casing 14 having a scroll shape in the first to third embodiments may be changed so as to have a shape for introducing a flow from a periphery of the container 12, 112, or the outlet 226 of the secondary cylinder 200. Furthermore, although not shown in the drawings, when the divided air introduction passages 56b as shown in FIG. 12 serve as the swirler 16, for example, extension pipes may be connected to the air introduction passages 56b, and an inflow pipe to join the extension pipes may be provided instead of the inflow casing 14. The aforementioned equivalent structures of the inflow casing 14 can similarly be applied to the all of the following embodiments.

Here, the arrangement of the fuel nozzle 18 can be changed in various manners. The single nozzle in the third embodiment shown in FIGS. 8 and 9 can be achieved most typically by spiral-type nozzle tips, or by nozzle tips having a large number of nozzle holes with a radially outward divergence angle with respect to the central axis of the container 212, which is not shown in the drawings. Nozzle tips having good atomization characteristics may be used even though they have a complicated structure.

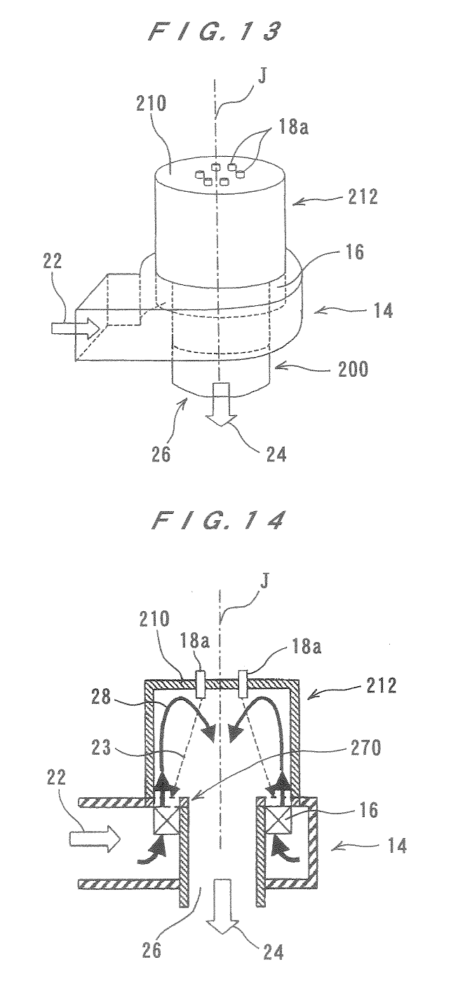

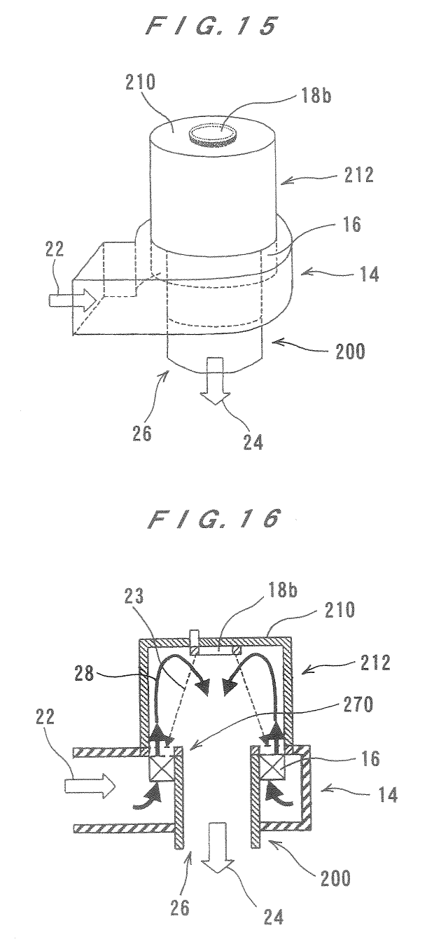

In another arrangement of the fuel nozzle, as shown in FIGS. 13 and 14, a plurality of nozzles 18a may be disposed substantially coaxially with the close end 210 of the container 212 instead of a single fuel nozzle. This case can also achieve the same effects as a single nozzle as long as fuel is injected from the close end 210 of the container 212 toward the outlet 26 in the form of a jet, or a cone having a relatively small divergence angle, or a sector so as to be directed to the inflow portions 20 for the combustion air with a radially outward angle with respect to the central axis J of the container 212. Particularly, a plurality of nozzles 18a are effective in a large-sized combustion apparatus having a difficulty in applying a single nozzle. As shown in FIGS. 15 and 16, still another arrangement of the fuel nozzle can be achieved by a hollow ring 18b having a large number of holes. The aforementioned equivalent structures of the fuel nozzle (18, 18a, 18b) can be applied to the first to third embodiments and all of the following embodiments.

The inventors conducted combustion tests with liquid fuel in the combustion apparatus of the third embodiment and found the following things. Two flames were formed so that one was formed near the center of the container while another was formed annularly near the peripheral portion of the container. The flame near the center of the container was uniform and slightly blue, and the annular flame near the peripheral portion of the container was very lean, uniform, and blue. Considering the phenomenon, pre-evaporation and premixed combustion were performed. As a result, generation of NOx was suppressed.

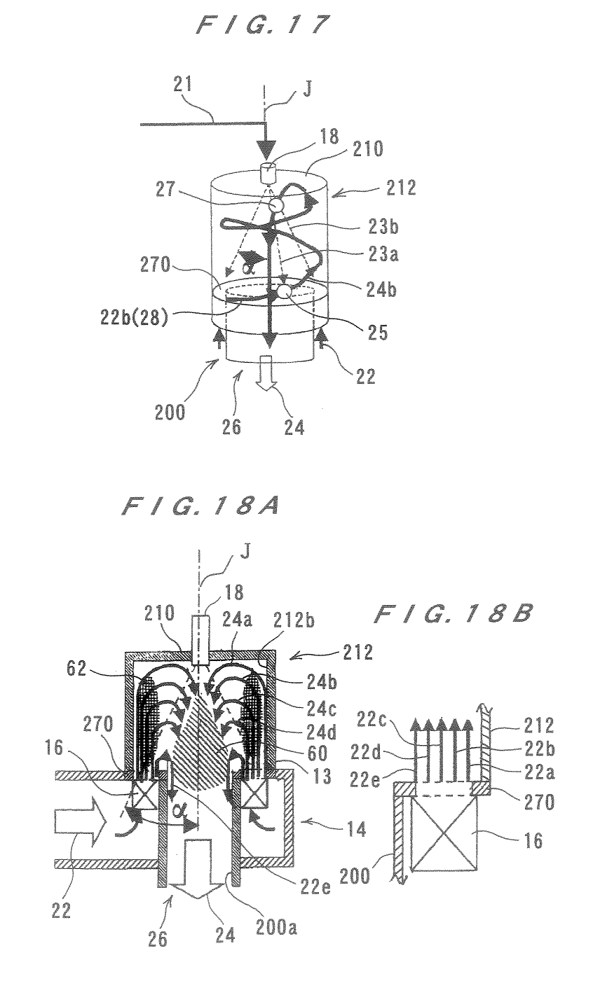

Effects of the illustrated embodiments will be described in greater detail with reference to FIGS. 17, 18A, and 18B, using the example of the third embodiment shown in FIGS. 8 and 9.

As shown in FIGS. 17, 18A, and 18B, fuel 21 is injected from the fuel nozzle 18 with a radially outward divergence angle a with respect to the central axis J of the container 212 (a track denoted by the reference numeral 23). Now is considered some fuel tracks 23a and 23b (see FIG. 17) of the fuel injected (i.e., the fuel injected toward the air inflow portions 20 with a velocity component in the direction of the central axis J from the close end 210 to the open end 26 and a velocity component directed radially outward) with a divergence angle α with respect to the axial direction of the container 212.

Referring to FIG. 17, the combustion air 22b flowing into the container 212 from a certain location in a circumferential direction swirls and goes upstream in a direction opposite to the outlet 26 within the container 212 (i.e., the air 22b forms a flow 28 which has a velocity component in the direction of the central axis J of the cylindrical container 212 from the open end 26 to the close end 210 and swirls in a circumferential direction of the cylindrical container 212) and intersects one track 23a at a location 25.

In a case of liquid fuel, the diameter of particles in fuel passing through the fuel track 23a becomes small at the location 25 because the fuel has been evaporated to some extent. The speed of the fuel 21 is lower than that near an outlet of the nozzle 18 because the fuel has moved in an air flow. Because the velocities of the fuel 21 and the combustion air 22b are opposed to each other, the fuel 21 rides on a flow of the combustion air 22b. Thus, the fuel 21 is ignited and combusted to form a flame.

The combustion air 22b further swirls and goes upstream in a direction opposite to the outlet within the container 212 so as to become a combustion gas 24b having a high temperature and a low oxygen concentration. As the combustion gas 24b comes close to the close end 210 of the container 212, the combustion gas 24b changes its direction so as to be close to the central axis J of the container 212. The combustion gas changes its direction into a direction of the outlet 26 near the central axis J of the container 212 and crosses the fuel track 23b at a location 27. Specifically, burnt gas recirculation occurs. In FIG. 18A, the fuel track 23b crossed by the combustion gas 24a may be the same as the fuel track 23a.

At the location 27, the combustion gas 24b having a high temperature and a low oxygen concentration does not ignite the fuel but pre-evaporates the fuel. The evaporated fuel flows together with the combustion gas 24b. Although the combustion gas 24b has a high temperature, it has a low oxygen concentration. Thus, the combustion gas 24b suppresses a combustion rate. Accordingly, the evaporated fuel is not ignited immediately but is premixed. After a certain period of time, the evaporated fuel is ignited and combusted, and the combustion gas 24b becomes a combustion gas 24 having a higher temperature and a lower oxygen concentration, which is discharged from the outlet 26.

Unlike conventional technology, in the illustrated embodiment (the third embodiment illustrated in FIGS. 17, 18A, and 18B), it is important that actual ignition and combustion at a low oxygen concentration by first bringing most of fuel into contact with the combustion gas 24b, not first bringing most of fuel into contact with the combustion air 22 can be achieved.

In the embodiment as illustrated in FIGS. 17, 18A, and 18B, if less evaporation of the fuel should be caused near a root of the fuel track 23, more fuel is mixed with the combustion air 22b at a tip of the fuel track 23 to increase the temperature of the combustion gas 24b. Thus, evaporation is promoted at the root of the fuel track 23 Specifically, a feedback effect is obtained with respect to the amount of evaporation. Accordingly, even if conditions of fuel injection are changed, the effects according to the embodiments of the present invention can stably be obtained.

In a case of gaseous fuel, the fuel is injected so as to penetrate a flow of air in a jet state and reach the location 25 before the fuel jet loses its momentum while its peripheral portion is partially mixed with the air. As with the case of liquid fuel, the combustion air 22b swirls and goes upstream in a direction opposite to the outlet 26 within the container 212 and intersects the fuel track 23a, so that the combustion air 22b is mixed with the fuel 21 so as to become a combustion gas 24b having a high temperature and a low oxygen concentration.

As the combustion gas 24b comes close to the close end 210 of the container 212, the combustion gas 24b changes its direction so as to be close to the central axis J of the container 212. The combustion gas 24b turns its direction near the central axis J and crosses the fuel track 23b at the location 27. Thus, burnt gas recirculation occurs. Although the combustion gas 24b has a high temperature, it has a low oxygen concentration. Thus, the combustion gas 24b suppresses a combustion rate. Accordingly, the fuel is not ignited immediately but is premixed. After a certain period of time, the fuel is ignited and combusted.

A fundamental effect in the illustrated embodiment described with reference to FIGS. 17, 18A and 18B is as follows. Air and fuel flow within the combustion apparatus in the following manner. Specifically, the directions of flows of air and fuel are changed in the combustion apparatus. The tracks of the combustion air and the fuel are not the same in the combustion apparatus. The track of the air and the track of the fuel intersect each other two times. The first intersection of the air is located near the tip of the fuel track, and the second intersection of the air is located in a region from a root of the fuel track to the vicinity of the tip. By mixing the fuel and the air with each other in the above manner, burnt gas recirculation is positively controlled and generated.

A flow in the combustion apparatus of the illustrated embodiment will be described in a cross-section passing through the central axis of the container 212 is shown as FIGS. 18A and 18B. In FIG. 18B, the combustion air 22 flowing into the container 212 is schematically illustrated as divided parts 22a, 22b, 22c, and 22d according to positions.

As shown in FIG. 18A, most 22b, 22c, and 22d of the combustion air 22 flowing into the cylindrical container 212 collide with the fuel track 23, respectively, become into combustion gases 24b, 24c, and 24d, go upstream deeply within the container 212, and intersect the fuel track 23 again. As an inflow position of the combustion air is farther away from the outer periphery 13 of the container 212, the combustion air goes upstream only to a shallower location and then turns its direction. Of the combustion air 22 flowing into the container 212, the combustion air 22a flowing from the location closest to an inner surface 212b of the container 212 goes upstream to the deepest location in the container 312 without colliding with the fuel 21. As the combustion air 22a goes upstream, it is mixed with the combustion gas 24b so as to become a combustion gas 24a. Thus, the combustion gases 24a, 24b, 24c, and 24d uniformly cross the fuel track 23. Effects of the burnt gas recirculation can be achieved most effectively. Specifically, one of the most fundamental effects according to the illustrated embodiment is the fact that the combustion gas uniformly crosses the track 23 of the fuel.

With these effects, in the combustion apparatus according to the illustrated embodiment, as shown in FIG. 18A, there are formed two flames of a primary flame 60 near the central axis J of the container and an annular flame 62 near the outer periphery of the container but away from an inner wall of the container 212.

The annular flame 62 has a long residence time in the container 212 because the combustion air 22 swirls. The annular flame 62 becomes uniform because it is well mixed in the circumferential direction. An increase of temperature of the combustion air 22 and a reduction of oxygen concentration, which are caused by the fact that the combustion air 22 and the fuel 21 are opposing each other and by the fact that a combustion gas having a high temperature is supplied to the combustion air that is to be mixed with the fuel 21 (23) from the main flame 60 with turbulent diffusion, promote evaporation of the fuel while suppressing ignition of the fuel. Accordingly, the stability of the flame is enhanced.

Further, since the combustion gases 24a, 24b, 24c, and 24d of the annular flame 62 cross the fuel track 23, the annular flame 62 serves as a reliable ignition source to enhance the stability of the main flame 60. Combustion occurs with the combustion gas having a high temperature and a low oxygen concentration in the main flame 60. Accordingly, pre-evaporation combustion, premixed combustion, and slow combustion are achieved. Unlike usual diffusive combustion, no areas having a high temperature are produced locally in the combustion. The combustion is uniform with a low maximum flame temperature. An average flame temperature is low due to the heat capacity of an inert gas in the combustion gas. Accordingly, generation of thermal NOx is suppressed.

An advantage in cooling in the illustrated embodiment will be described. Of the combustion air 22 flowing into the container 212 as shown in FIGS. 18A and 18B, the combustion air 22a flowing from the location closest to the inner surface 212b of the container 212 goes upstream deepest within the container 212 without colliding with the fuel 21. As the combustion air goes upstream, it is mixed with the combustion gas 24b so as to become the combustion gas 24a. Since the combustion gas 24a has a relatively low temperature, the inner surface of the container 212 is protected from being overheated.

Meanwhile, the combustion air 22e flowing from the farthest location away from an inner surface 212b of the container 212 into the container 212 turns at a location closer to the outlet 26 than the reaching point of the fuel 21 (23) and flows toward the outlet 26. Accordingly, the combustion air 22e does not become a combustion gas but is mixed with the combustion gas of the main flame 60 gradually from a portion near the central axis J of the secondary cylinder 200. However, the turned combustion air 22e has a relatively low temperature at a portion closest to the inner surface 200a of the secondary cylinder 200. Thus, the inner surface 200a of the secondary cylinder 200 is protected from a high temperature of the primary flame 60.

Although FIGS. 17, 18A, and 18B show the third embodiment, the aforementioned effects can also be applied to the first and second embodiments and the following embodiments.

Further, the following is advantageous in structure. Since the combustion chamber is divided into the container 212 and a downstream structure (secondary cylinder 200), the container 212 can readily be taken out. As compared to the conventional technology, disassembly, replacement, and adjustment of the combustion apparatus are facilitated to improve easiness of maintenance.

Next, a fourth embodiment, which is equivalent to the aforementioned third embodiment, i.e., is compatible with the aforementioned third embodiment, will be described with reference to FIG. 19. In the combustion apparatus of the fourth embodiment shown in FIG. 19, the close end 310 of the container 312 is formed in the form of a dome by a free-form arc having a nonuniform curvature, unlike the first embodiment to the third embodiment. A secondary cylinder 200 is connected to an inner side of a lower end 312a of the domelike container 312 via a connecting member 270.

The combustion apparatus in the fourth embodiment shown in FIG. 19 can also achieve the same effects as described in the third embodiment. Since the close end 310 of the container 312 is formed by a curved surface, it is possible to facilitate manufacturing and reduce cost in a case where the container 312 is made of a heat resistant material such as ceramics, particularly, for the purpose of a high combustion temperature. Further, since the combustion chamber is divided into the container 312 and a downstream structure (secondary cylinder 200), the container 312 can readily be taken out. As compared to the conventional technology, disassembly, replacement, and adjustment of the combustion apparatus are facilitated to improve easiness of maintenance. The container 312 partially including a curved surface in the fourth embodiment shown in FIG. 19 may be applied to the first and the second embodiments.

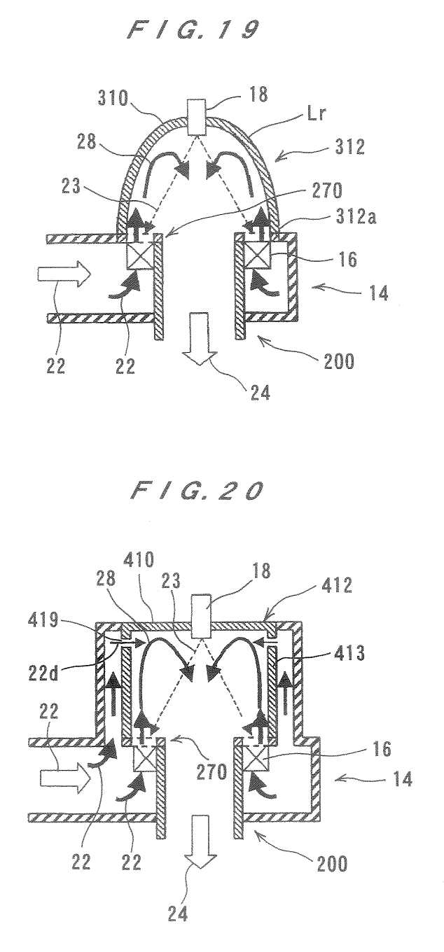

Next, a combustion apparatus according to a fifth embodiment will be described with reference to FIG. 20. The fifth embodiment of FIG. 20 is an application of the third embodiment shown in FIGS. 8 and 9. That is, auxiliary air holes are formed near the close end of the container in the third embodiment. Specifically, in the embodiment of FIG. 20, the combustion apparatus in the fifth embodiment has a plurality of auxiliary air holes 419 formed in a side surface 413 near the close end 410 of the container 412.

The combustion air 22d flowing through a plurality of auxiliary air holes 419 thus formed in the side surface 413 near the close end 410 flows centrally into the container 412 in a jet state. Accordingly, the combustion gas 24b therearound is induced so as to promote a flow directed to the center of the container 412 near the close end 410 of the container 412. The swirling and flowing combustion gas 24b can be introduced into a central portion of the cylindrical container 412 at a location near the close end 410 of the cylindrical container 412 and recirculated toward the fuel track 23. The auxiliary air holes 419 in the fifth embodiment may be applied to the first and second embodiments.

Next, a combustion apparatus according to a sixth embodiment will be described with reference to FIG. 21. In the sixth embodiment shown in FIG. 21, a plurality of guide vanes 11 are provided as a flow adjusting structure inside of the close end 210 of the container 212 in the third embodiment shown in FIGS. 8 and 9. Such guide vanes 11 can achieve the same effects as the auxiliary air holes 419 in the fifth embodiment (see FIG. 20). This embodiment is substantially the same as the third embodiment shown in FIGS. 8 and 9 except that a plurality of guide vanes 11 are provided as a flow adjusting structure inside of the close end 210 of the cylindrical container 212. Further, the guide vanes 11 can also be applied to the first embodiment, the second embodiment, and the fifth embodiment.

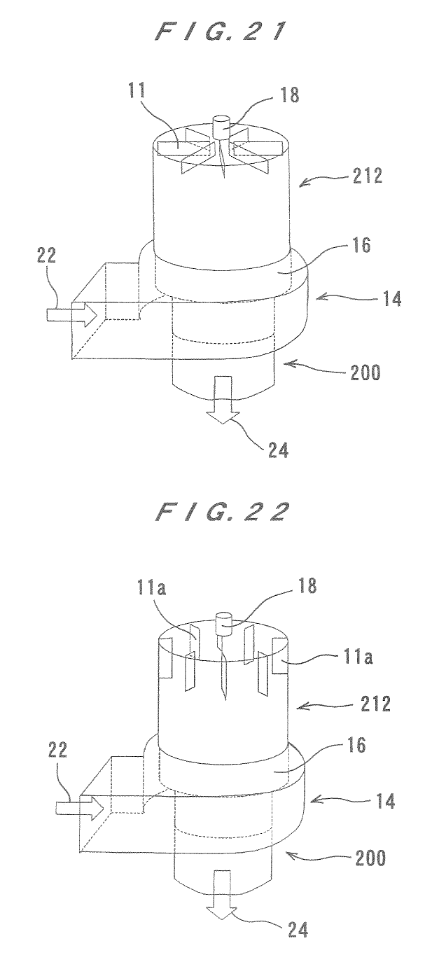

Next, a combustion apparatus according to a seventh embodiment will be described with reference to FIG. 22. In the seventh embodiment shown in FIG. 22, a plurality of guide vanes 11a are provided as a flow adjusting structure on an inner side wall 213 near the close end 210 of the container 212 in the third embodiment shown in FIGS. 8 and 9 to achieve the same effects as the auxiliary air holes 419 in the fifth embodiment shown in FIG. 20. This embodiment is substantially the same as the third embodiment except that a plurality of guide vanes 11a are provided as a flow adjusting structure on the inner side wall 213 near the close end 210 of the container 212. Further, the guide vanes 11a can also be applied to the first, second, and fifth embodiments. Furthermore, the flow adjusting structure shown in the sixth and seventh embodiments may be both provided.

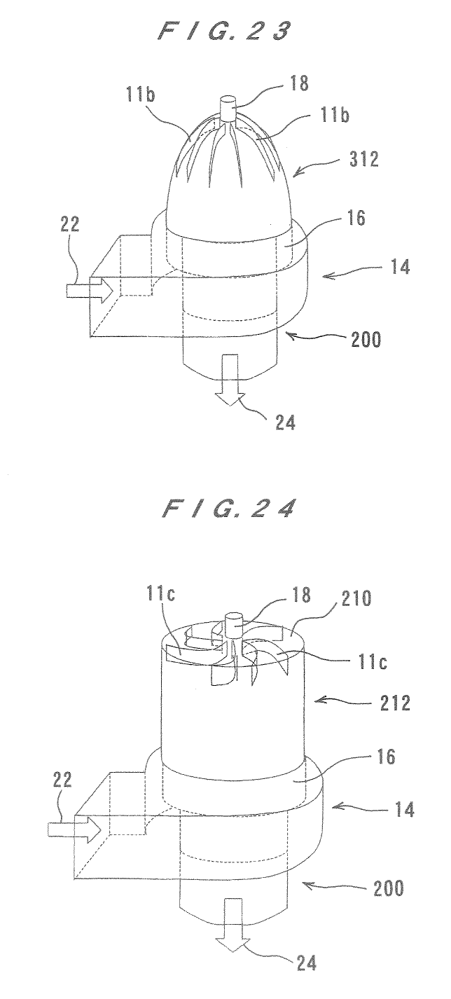

Next, a combustion apparatus according to an eighth embodiment will be described with reference to FIG. 23. In the eighth embodiment shown in FIG. 23, as with the sixth and seventh embodiments, guide vanes 11b are applied to the fourth embodiment shown in FIG. 19. Specifically, the guide vanes 11b are formed so as to extend along an inner curved surface of the close end 310 of the domelike container 312, which is formed by a curved surface, substantially to a top of the close end 310.

Each of the guide vanes 11, 11a, and 11b shown in the six to eighth embodiments has a function to suppress an air flow having a velocity component in the direction of the central axis J of the cylindrical container 212 from the open end 26 to the close end 210 and swirling in a circumferential direction of the cylindrical container 212 and/or to regulate the air flow in a radial direction near the close end 210 or 310 of the container 212 or 312. Then, the swirling and flowing combustion gas 24b (see FIG. 20) can be introduced into a central portion of the close end 210 or 310 of the cylindrical container 212 or 312 and smoothly recirculated toward the fuel track 23, as with the fifth embodiment shown in FIG. 20.

Ninth to eleventh embodiments, which are further developments of the sixth to eighth embodiments, will be described with reference to FIGS. 24 through 26.

First, in the ninth embodiment shown in FIG. 24, the guide vanes 11 as a flow adjusting structure in the sixth embodiment shown in FIG. 21 are optimized. Specifically, guide vanes 11c in the ninth embodiment are curved in an arc form such that the shape of the guide vanes 11 in the sixth embodiment shown in FIG. 21 spirals toward the center of the container 212 so as to facilitate the flow of the combustion air flowing (swirling) into the central portion of the container 212. The guide vanes 11c can also be applied to the first, second, and fifth embodiments. Further, the guide vanes 11c can be used together with the guide vanes 11a in the seventh embodiment.

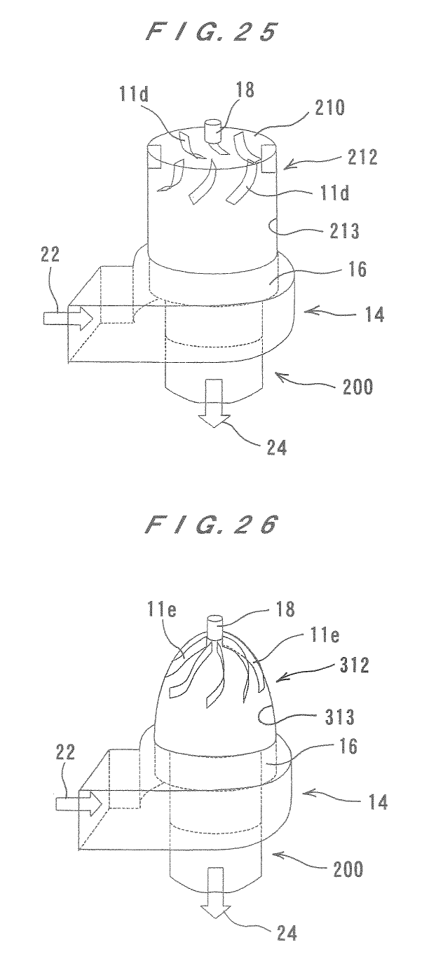

In the tenth embodiment shown in FIG. 25, the guide vanes 11a as a flow adjusting structure in the seventh embodiment shown in FIG. 22 are optimized. Specifically, guide vanes 11d in the tenth embodiment are deformed such that the shape of the guide vanes 11a in the seventh embodiment shown in FIG. 22 is inclined along an inner wall 213 of the container 212 while upper ends of the guide vanes 11d are directed in a vertical direction in the illustrated example. The guide vanes 11d can also be applied to the first, second, and fifth embodiments. Further, the guide vanes 11d can be used together with the guide vanes 11c shown in the ninth embodiment or the guide vanes 11 in the sixth embodiment.

In the eleventh embodiment shown in FIG. 26, the guide vanes 11b as a flow adjusting structure in the eighth embodiment shown in FIG. 23 are optimized. Specifically, guide vanes 11e in the eleventh embodiment are deformed such that the shape of the guide vanes 11b in the eighth embodiment shown in FIG. 23 is inclined along a curved dome inner wall of the domelike container 312 while upper ends of the guide vanes 11e are directed in a vertical direction in the illustrated example.

In the ninth to eleventh embodiments, the flow adjusting structure (guide vanes) 11c, 11d, or 11e has an effect to centrally deflect a flow of the swirling combustion gas 24a (not shown) positively and more smoothly. Thus, the swirling and flowing combustion gas 24a can be more smoothly introduced into the central portion of the container 212 or 312 and recirculated toward the fuel track 23 near the close end 210 or 310 of the container 212 or 312.

Even if the detail of the shape of the flow adjusting structure is changed, it is substantially equivalent to the above flow adjusting structure as long as it has an effect to deflect the swirling flow into a centrally directed flow. Further, the flow adjusting structure may include plate-like or stand-like objects attached to the container 212 or 312, or may include grooves formed in the inner surface of the container 212 or 312.

Next, a combustion apparatus according to a twelfth embodiment, which is an application of the third embodiment, will be described with reference to FIG. 27. In this combustion apparatus, auxiliary fuel nozzles 502 for accessorily injecting fuel are provided on an inner surface 513 of the container 512 in the position slightly away from the inflow portions 20 for the combustion air 22 toward the close end 510.

Fuel injected from the auxiliary fuel nozzles 502 may be the same as or different from the fuel injected from the main fuel nozzle 18. Even if the fuel 21 has a difficulty to reach the inflow portions 20 (not shown) for the combustion air 22 because the combustion apparatus has a large size or a limited injection pressure in a case of gaseous fuel, injection of the same fuel from the auxiliary fuel nozzles 502 achieves combustion with suppressing regeneration of thermal NOx due to burnt gas recirculation, as with the third embodiment shown in FIGS. 8 and 9.

Further, liquid/gas multi fuel combustion can be achieved with a simple arrangement by injecting liquid fuel from the fuel nozzle 18 and injecting gaseous fuel from the auxiliary fuel nozzles 502. Turndown performance can further be improved by the auxiliary fuel nozzles 702. Further, when fuel having such a low heating value that stable combustion is difficult is used, particularly when fuel like waste liquid, which has a low heating value, is used, injection of fuel having a low heating value or waste liquid from the fuel nozzle 18 and injection of fuel having good combustibility from the auxiliary fuel nozzles 502 produce pre-evaporated and premixed fuel by burnt gas recirculation to achieve combustion with suppressing generation of thermal NOx, as with the third embodiment.

In FIG. 27, the auxiliary fuel nozzles 502 include a plurality of nozzles provided on the inner surface of the container 512. As another arrangement, a single ring having a large number of injection holes (not shown) may be disposed on the inner side surface of the container 512.

The auxiliary fuel nozzles 502 in the twelfth embodiment are also applicable to the first, second, and fourth to eleventh embodiments.

When the present invention is applied to a combustion apparatus in a gas turbine, the aforementioned embodiments (the first embodiment to the twelfth embodiment) are regarded as a primary combustion zone, and additional air inflow portions are provided downstream of the outlet. Meanwhile, in a combustion apparatus of a gas turbine, many technologies have been known to add air downstream of a primary combustion zone in order to prevent a lowered combustion efficiency which causes discharge of unburnt components or an increased generation of NOx. Accordingly, when the present invention is applied to a gas turbine, known technology can be applied to the aforementioned embodiments. Thus, many applications can be achieved within the concept of the present invention. Not all of such applications can be explained, and some examples of such applications will be described below.

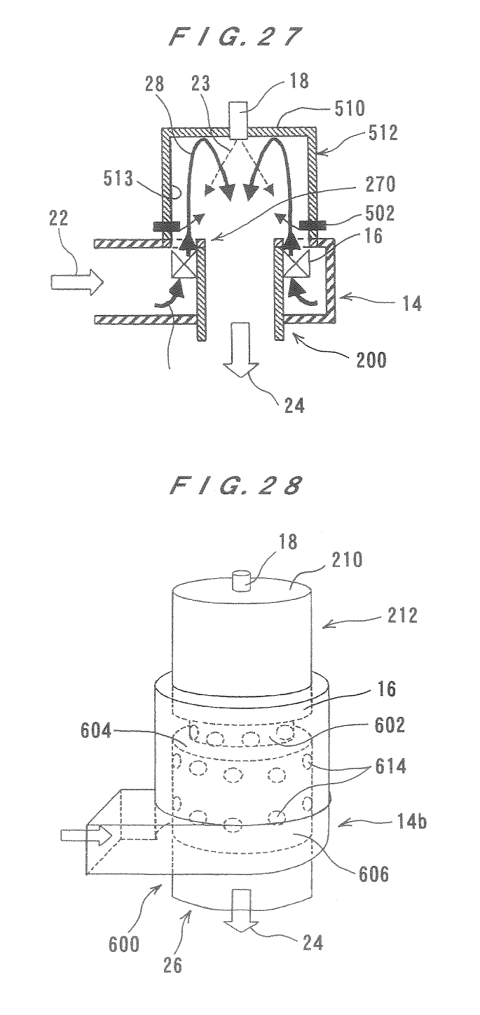

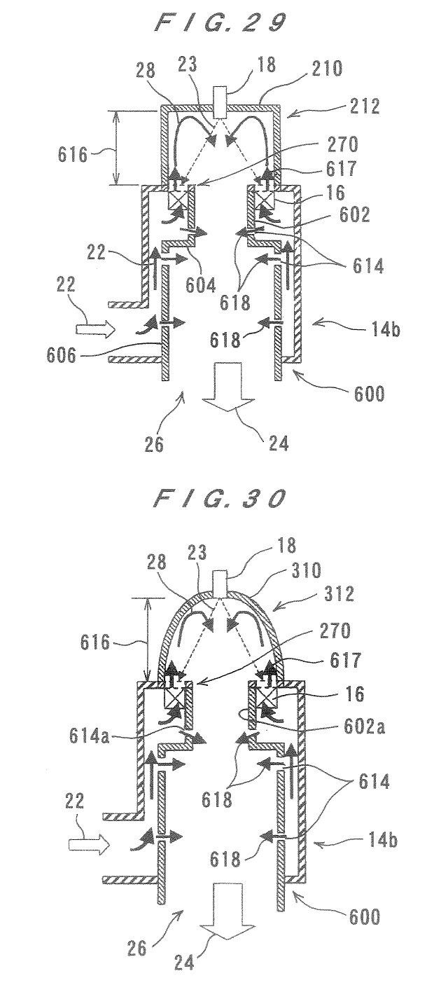

A combustion apparatus in a gas turbine according to a thirteenth embodiment will be described with reference to FIGS. 28 and 29. In the thirteenth embodiment shown in FIGS. 28 and 29, the combustion apparatus in the aforementioned third embodiment shown in FIGS. 8 and 9 is applied to a gas turbine combustion apparatus.

As compared to the third embodiment, the gas turbine combustion apparatus shown in FIGS. 28 and 29 includes a secondary cylinder 600 having two cylinders having different cross-sections, which includes a small diameter portion connected to the connecting member 270 at an upper portion thereof and a large diameter portion 606 connected to the small diameter portion 602 via a step portion (cross-section enlarged portion) 604. In the illustrated example, a plurality of air holes 614 are formed at equal pitches in each stage. One set of air holes is formed in the small diameter portion 602, and two sets of air holes are formed in the large diameter portion 606.

The secondary cylinder 600 is enlarged in cross-section at a downstream portion, which is arbitrary. Further, although the secondary cylinder 600 is integrally formed including the outlet 26, it may be divided for manufacturing requirements. The inflow casing 14 is replaced with an inflow casing 14b enlarged so as to correspond to the secondary cylinder 600.

Secondary and dilution air 618 flows through the air holes 614 and 814b formed as a plurality of stages around the secondary cylinder 600. As with the third embodiment shown in FIGS. 8 and 9, burnt gas recirculation occurs uniformly along a fuel track 23 in the primary combustion zone 816 to perform combustion with a combustion gas having a high temperature and a low oxygen concentration Accordingly, pre-evaporation combustion is achieved in a case of liquid fuel, and premixed combustion and slow combustion are achieved in a case of gaseous fuel or liquid fuel. Uniform combustion with a low maximum flame temperature can be performed (unlike usual combustion in which areas having a theoretical mixture ratio and a high temperature are produced locally in the combustion). An average fame temperature is lowered due to the heat capacity of an inert gas in the combustion gas. Accordingly, generation of thermal NOx is suppressed. The wall surface of the cylinder 600 to the uppermost secondary air holes 614 of the secondary cylinder 600 is cooled by a portion of the primary air 617 as with the third embodiment.

Cooling air holes, which are not shown in the drawings, may optionally be formed in a wall surface of the secondary cylinder 600 from the secondary air holes 614 to the outlet. Further, because the stability of the primary combustion zone 616 is high, a ratio of a flow rate of the primary air 617 to a total flow rate of air can be increased to perform leaner primary combustion so as to lower a combustion temperature. Accordingly, it is possible to further suppress generation of thermal NOx.

Further, the following is advantageous in structure. Unlike conventional technology, the primary air 617 flows through a location closest to the outlet 26 in the primary combustion zone 616. Accordingly, the secondary cylinder 600 is fixed with respect to the inflow casing 14b at two locations including the location closest to the outlet 26 in the primary combustion zone 616 and the outlet of the secondary cylinder 600. Therefore, it is not necessary to provide a dual structure in which the outside of the primary combustion zone 616 is enclosed by the inflow casing 14b. The container 212 is exposed in the primary combustion zone. Accordingly, the fuel nozzle 18 and an ignition device, which is not shown in the drawings, can be attached directly to the container 212 without extending through the inflow casing 14b. Thus, the structure can be simplified, and cost can be reduced. As a matter of course, it is desirable that the exposed container 212 is thermally insulated by a heat insulator.

Further, the secondary cylinder 600 is fixed to the inflow casing 14b by a short portion, which is in a secondary combustion/dilution zone having a relatively low temperature. Accordingly, the amount of thermal expansion of the secondary cylinder 600 is reduced. Thus, the container 212 can be fixed to the inflow casing 14b with a simpler structure, and cost can be reduced. Further, thermal expansion of the container 212 is negligible because the close end 210 of the container 212 is not restricted. Furthermore, since the combustion chamber is divided into the container 212 and a downstream structure (secondary cylinder 200), the container 212 can readily be taken out. As compared to the conventional technology, disassembly, replacement, and adjustment of the combustion apparatus are facilitated to improve easiness of maintenance.

When the first, second, and six to twelfth embodiments are applied to a gas turbine combustion apparatus instead of the third embodiment, it is possible to achieve the operations and effects of the thirteenth embodiment. At that time, the operations and effects of the first, second, and six to twelfth embodiments can also be achieved.

Next, a gas turbine combustion apparatus according to a fourteenth embodiment will be described with reference to FIG. 30. In the fourteenth embodiment shown in FIG. 30, the combustion apparatus in the fourth embodiment is applied to a gas turbine combustion apparatus.

As compared to the fourth embodiment, in the gas turbine combustion apparatus shown in FIG. 30, the secondary cylinder is replaced with a secondary cylinder 600 which is extended toward the outlet 26 and has air holes 614 formed at proper positions. Further, the secondary cylinder 600 is enlarged in cross-section at a downstream portion, which is arbitrary. Furthermore, although the secondary cylinder 600 is integrally formed including the outlet 26, it may be divided for manufacturing requirements. The inflow casing 14 is replaced with an inflow casing 14b extended so as to correspond to the secondary cylinder 600. Secondary and dilution air 818 flows through the air holes 614.

As with the fourth embodiment shown in FIG. 19, burnt gas recirculation occurs uniformly along a fuel track 23 in the primary combustion zone 616 to perform combustion with a combustion gas having a high temperature and a low oxygen concentration. Accordingly, pre-evaporation combustion is achieved in a case of liquid fuel, and premixed combustion and slow combustion are achieved in a case of gaseous fuel or liquid fuel. Uniform combustion with a low maximum flame temperature can be performed (unlike usual combustion in which areas having a theoretical mixture ratio and a high temperature are produced locally in the combustion). An average flame temperature is lowered due to the heat capacity of an inert gas in the combustion gas. Accordingly, generation of thermal NOx is suppressed. The wall surface 602a to the uppermost secondary air holes 614a of the secondary cylinder 600 is cooled by a portion of the primary air 617 as with the fourth embodiment.

Cooling air holes, which are not shown in the drawings, may optionally be formed in a wall surface of the secondary cylinder 600 from the secondary air holes 614 to the outlet 26.

Further, because the stability of the primary combustion zone 616 is high, a ratio of a flow rate of the primary air 617 to a total flow rate of air can be increased to perform leaner primary combustion so as to lower a combustion temperature. Accordingly it is possible to further suppress generation of thermal NOx. Since the close end 310 of the container 312 is formed by a domelike curved surface, it is possible to facilitate manufacturing and reduce cost in a case where the cylindrical container 312 is made of a heat resistant material such as ceramics, particularly, for the purpose of a high combustion temperature.

Further, the following is advantageous in structure. Unlike conventional technology, the primary air 617 flows through a location closest to the outlet 26 in the primary combustion zone 616. Accordingly, the secondary cylinder 600 is fixed with respect to the inflow casing 14b at two locations including the location closest to the outlet in the primary combustion zone 616 and the outlet of the secondary cylinder 600. Therefore, it is not necessary to provide a dual structure in which the outside of the primary combustion zone 616 is enclosed by the inflow casing 14b. The container 312 is exposed in the primary combustion zone. Accordingly, the fuel nozzle 18 and an ignition device, which is not shown in the drawings, can be attached directly to the container 312 without extending through the inflow casing 14b. Thus, the structure can be simplified, and cost can be reduced. As a matter of course, it is desirable that the exposed container 312 is thermally insulated by a heat insulator.

Further, the secondary cylinder 600 is fixed to the inflow casing 14b by a short portion, which is in a secondary combustion/dilution zone having a relatively low temperature. Accordingly, the amount of thermal expansion of the secondary cylinder 600 is reduced. Thus, the container 312 can be fixed to the inflow casing 14b with a simpler structure, and cost can be reduced. Further, thermal expansion of the container 312 is negligible because the close end 310 of the container 312 is not restricted. Furthermore, since the combustion chamber is divided into the container 312 and a downstream structure (secondary cylinder 600), the container 312 can readily be taken out. As compared to the conventional technology, disassembly, replacement, and adjustment of the combustion apparatus are facilitated to improve easiness of maintenance.

Next, a gas turbine combustion apparatus according to a fifteenth embodiment will be described with reference to FIG. 31. In the fifteenth embodiment shown in FIG. 31, the combustion apparatus in the fifth embodiment shown in FIG. 20 is applied to a gas turbine combustion apparatus.

As compared to the fifth embodiment, in the gas turbine combustion apparatus shown in FIG. 31, the secondary cylinder is replaced with a secondary cylinder 600 which is extended toward the outlet 26, and having air holes 614 formed at proper positions. The inflow casing is replaced with an inflow casing 14c extended so as to correspond to the secondary cylinder 600. Secondary and dilution air 618 flows through the air holes 614.

As with the fifth embodiment shown in FIG. 20, burnt gas recirculation occurs uniformly along a fuel track 23 in the primary combust on zone 616 to perform combustion with a combustion gas having a high temperature and a low oxygen concentration. Accordingly, pre-evaporation combustion is achieved in a case of liquid fuel, and premixed combustion and slow combustion are achieved in a case of gaseous fuel or liquid fuel. Uniform combustion with a low maximum flame temperature can be performed (unlike usual combustion in which areas having a theoretical mixture ratio and a high temperature are produced locally in the combustion). An average flame temperature is lowered due to the heat capacity of an inert gas in the combustion gas. Accordingly, generation of thermal NOx is suppressed. The wall surface 602a to the uppermost secondary air holes 614 of the secondary cylinder 600 is cooled by a portion of the primary air 617 as with the fifth embodiment.

Cooling air holes, which are not shown in the drawings, may optionally be formed in a wall surface of the secondary cylinder 600 from the secondary air holes 614 to the outlet. Further, because the stability of the primary combustion zone 616 is high, a ratio of a flow rate of the primary air 617 to a total flow rate of air can be increased to perform leaner primary combustion so as to lower a combustion temperature. Accordingly, it is possible to further suppress generation of thermal NOx.

Further, the following is advantageous in structure. Unlike conventional technology, air flows through a location closest to the outlet 26 in the primary combustion zone 616 and the close end 410 of the container 412. Accordingly, the secondary cylinder 600 is fixed with respect to the inflow casing 14c at two locations including the close end 410 of the container 412 and the outlet of the secondary cylinder 600. Therefore, it is not necessary to provide a dual structure in which the outside of the close end 410 of the container 412 is enclosed by the inflow casing 14c. The close end 410 of the container 412 is exposed. Accordingly, the fuel nozzle 18 and an ignition device, which is not shown in the drawings, can be attached directly to the close end 410 of the container 412 without extending through the inflow casing 14c. Thus, the structure can be simplified, and cost can be reduced. As a matter of course, it is desirable that the exposed close end 410 of container 412 is thermally insulated by a heat insulator.

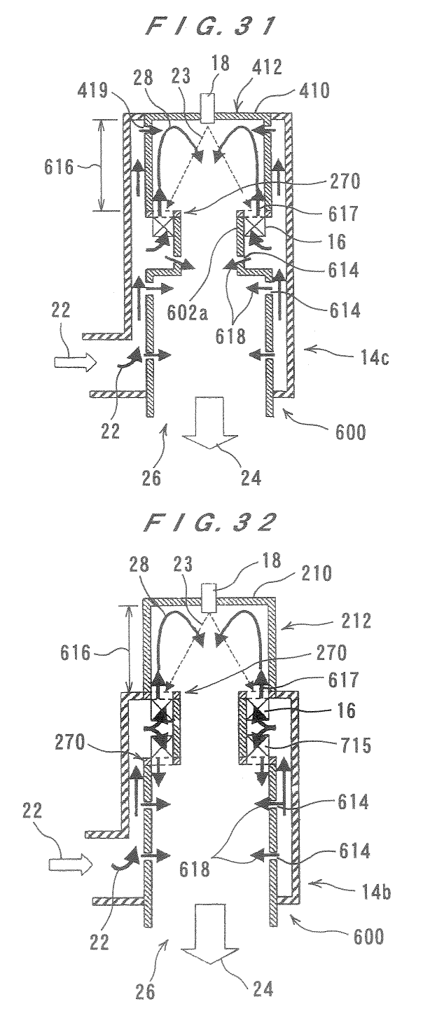

Next, a gas turbine combustion apparatus according to a sixteenth embodiment will be described with reference to FIG. 32. The sixteenth embodiment shown in FIG. 32 is an application of the thirteenth embodiment shown in FIG. 29.

This gas turbine combustion apparatus can promote mixing in a secondary zone by forming a swirling flow of secondary air 618 with the secondary swirler 715. The secondary swirler 715 in the present embodiment may be applied to the fourteenth and fifteenth embodiments. When air is to be added downstream of the primary combustion zone, known technology can be employed in order to prevent a lowered combustion efficiency which causes discharge of unburnt components or an increased generation of NOx. Thus, various applications can be obtained within the concept of the present invention.

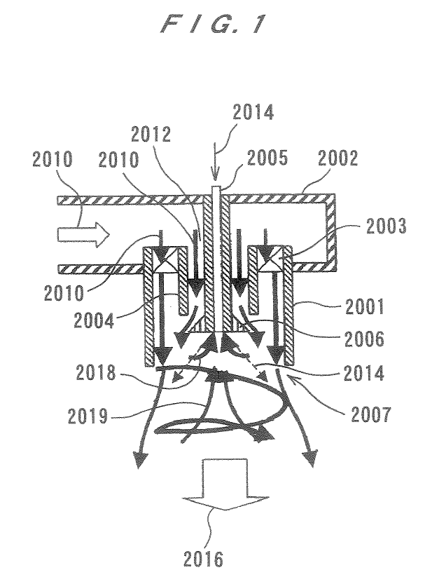

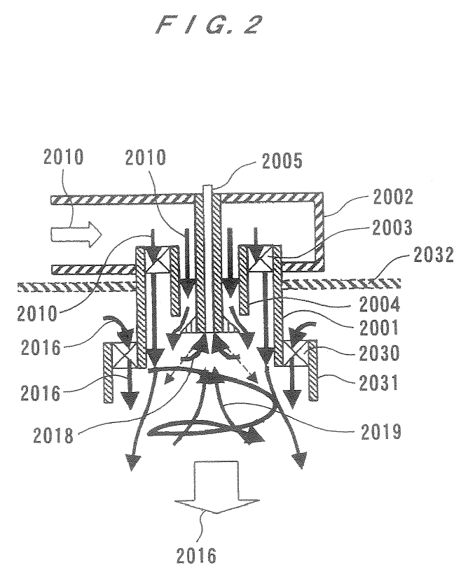

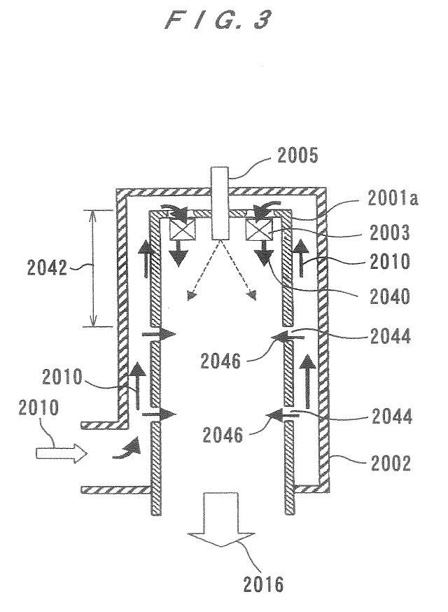

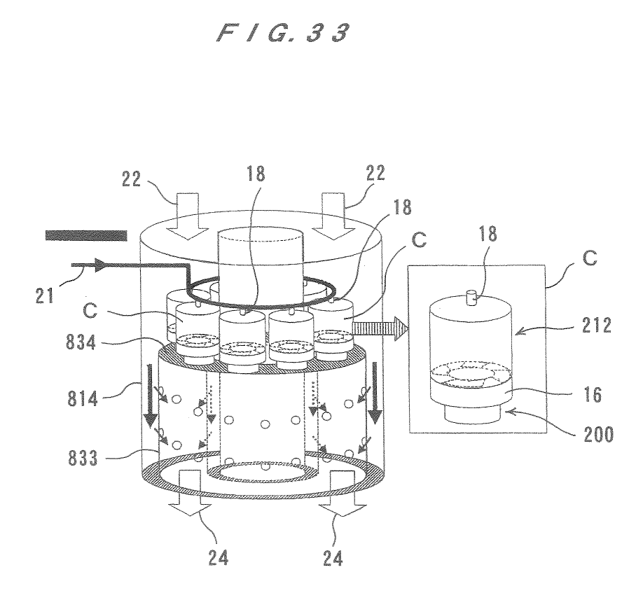

The aforementioned embodiments relate to a single cylinder (can type) combustion apparatus. Various types of conventional annular (ring) combustion apparatuses include an apparatus in which a plurality of combustion apparatuses of conventional technology as shown in FIG. 1, in which a flame is stabilized by swirling, are disposed as a primary combustion zone. The combustion apparatuses in the embodiments of the present invention can be applied as a primary combustion zone of an annular (ring) combustion apparatus with the essential effects of the present invention. A combustion apparatus according to a seventeenth embodiment, which is an annular combustion apparatus, will be described with reference to FIG. 33.

The combustion apparatus (FIG. 33) is an annular (ring) combustion apparatus in which a plurality of combustion apparatuses C (eight apparatuses in FIG. 33) of the third embodiment shown in FIGS. 8 and 9 are connected to a single secondary annular container 833 while an annular inflow casing 814 is used as the inflow casing. More specifically, ends of secondary cylinders 200 of a plurality of combustion apparatuses C are connected to a close end 834 of the secondary annular container 833.

When the first, second, fourth, and fifth to twelfth embodiments are applied to the present embodiment (seventeenth embodiment) instead of the third embodiment shown in FIGS. 8 and 9, it is possible to achieve the operations and effects of the first, second, fourth, and fifth to twelfth embodiments.

Although not shown in the drawings, the secondary swirler 715 of the sixteenth embodiment shown in FIG. 32 may be applied to the seventeenth embodiment shown in FIG. 33. Further, although not shown in the drawings, a plurality of combustion apparatuses of the third embodiment may be disposed not only in a circumferential direction of the secondary annular container 833, but also in a radial direction. This arrangement is particularly suitable for a large-sized annular combustion apparatus.

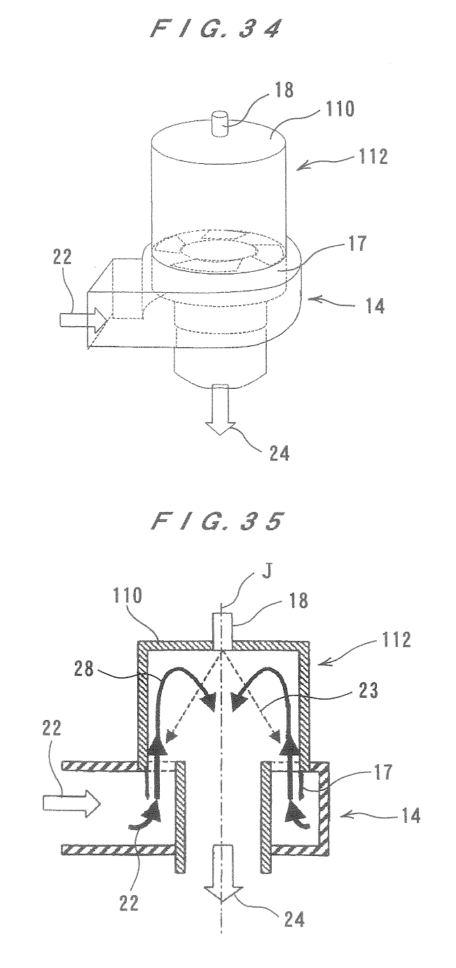

In the aforementioned embodiments, air is supplied into the combustion chamber while being swirled. FIGS. 34 and 35 show an example in which air is supplied without being swirled. Instead of the swirler, the combustion apparatus shown in FIGS. 34 and 35 uses introduction passages 17 for supplying air so as to have only a velocity component in a direction facing a flow of fuel with respect to a direction of a central axis of the combustion chamber at air inflow portions 20. With this arrangement, the following flow state can be formed. A track of an air flow and a track of a fuel flow are not the same. The track of the air flow and the track of the fuel flow intersect each other two times. The first intersection of the air flow with the track of the fuel flow is located near a tip of the fuel track, and the second intersection of the air flow with the track of the fuel flow is located in a region from a root of the track of the fuel flow to the vicinity of the tip.

FIGS. 34 and 35 show an arrangement in which no swirler is used in the second embodiment. No swirler may be used in the first and third to seventeenth embodiments. However, in the first to seventeenth embodiments using a swirler, the air flow becomes a swirling flow swirling along an inner wall surface of the combustion apparatus, so that centrifugal forces are applied to the air flow. Accordingly, the air flow can go upstream smoothly along the inner surface of the outer circumferential surface of the combustion apparatus by a long distance before the air flow changes its direction to a direction of the outlet of the combustion apparatus. Specifically, the arrangement shown in the first to seventeenth embodiments can form the aforementioned flow state more efficiently as compared to the arrangement representatively shown in FIGS. 34 and 35.

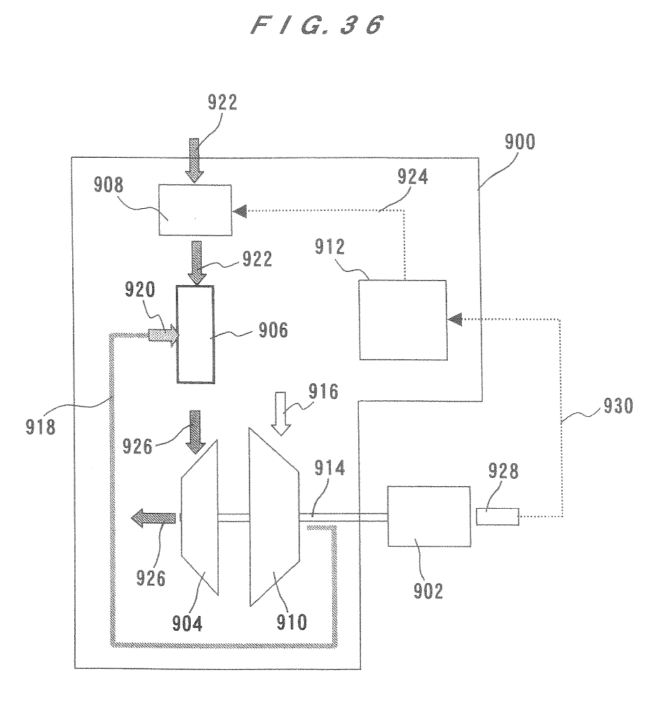

Next, an example in which a combustion apparatus of the aforementioned embodiments is applied to a gas turbine generator will be described with reference to FIG. 36. The gas turbine generator shown in FIG. 36 has a gas turbine apparatus 900 and a power generator 902.

The gas turbine apparatus 900 has a turbine 904 rotated by a combustion gas, a combustor 906 for combusting a gaseous mixture of fuel and air, a fuel control valve 908 for adjusting the amount of fuel to be supplied to the combustor 906, an air compressor 910 for transferring air to the combustor 906 under pressure, and a controller 912 for indirectly controlling the turbine 904. The combustion apparatus of the aforementioned embodiments is used as the combustor 906 in FIG. 36.

The turbine 904 has a plurality of rotary vanes, which are not shown in the drawings, rotated by receiving a combustion gas 926, is connected to the air compressor 910 via a rotational shaft 914, and is rotatably supported in a casing, which is not shown in the drawings. The air compressor 910 is driven via the rotational shaft 914 by the turbine 904 and is configured so as to compress air 916 supplied into the air compressor 910. The air compressor 910 is connected to the combustor 906 via a pipe 918. The air 920 compressed by the air compressor 910 is supplied via the pipe 918 to the combustor 906.

The fuel control valve 908 is disposed upstream of the combustor 906. Fuel 922 supplied from a fuel supply source, which is not shown in the drawings, passes through the fuel control valve 908, and is then supplied to the combustor 906. The fuel control valve 908 is operable to vary an opening of the valve. The opening is controlled via a control signal line 924 by the controller 912 to adjust the amount of fuel 922 to be supplied to the combustor 906.

The fuel 922 and the compressed air 920 supplied to the combustor 906 form a gaseous mixture in the combustor 906. When the gaseous mixture is combusted in the combustor 906, a combustion gas 926 having a high temperature and a high pressure is generated. The generated combustion gas 926 having a high temperature and a high pressure is supplied to the turbine 904 to rotate the turbine 904 at a high speed. The turbine 904 is coupled directly to the power generator 902 via the rotational shaft 914. When the turbine 904 is rotated, the power generator 902 is rotated to generate power.

A rotational speed detector 928 for detecting a rotational speed of the turbine 904 is provided near the rotational shaft 914 (near the power generator 902 in FIG. 36). Information of the rotational speed detected by the rotational speed detector 928 is transmitted through a signal line 930 to the controller 912. An arrangement and effects of the combustor 906 are the same as those of the combustion apparatus in the aforementioned embodiments.

As described above, when the embodiments of the present invention are applied to a general combustion apparatus, it is possible to positively control and generate burnt gas recirculation with a simple structure. Thus, the stability can be enhanced, and effects of burnt gas recirculation can be maximized.

Since effects of burnt gas recirculation can be maximized with high stability, it is possible to perform combustion with a combustion gas having a high temperature and a low oxygen concentration to achieve pre-evaporation combustion having stable evaporation characteristics in a case of liquid fuel, premixed combustion independent of gaseous fuel or liquid fuel, slow combustion, uniform combustion with a low maximum flame temperature, and combustion with a low average flame temperature due to the heat capacity of an inert gas in the combustion gas. Thus, it is possible to provide a combustion apparatus which can suppress generation of thermal NOx, which has been difficult to suppress with the conventional technology.

Since an inner wall of the combustion apparatus is suitably cooled by an air flow having a low temperature, it is possible to provide a combustion apparatus having a high durability.

It is possible to provide a combustion apparatus which can readily use a heat resistant material such as ceramics. Further, since disassembly and replacement are facilitated, it is possible to provide a combustion apparatus having easiness of maintenance.

When auxiliary fuel nozzles are provided, it is possible to provide a combustion apparatus which can suppress generation of thermal NOx in multi fuel combustion of gaseous fuel/liquid fuel and combustion with fuel or a waste liquid having a low heating value.

When the aforementioned embodiments are applied to a primary combustion zone of a gas turbine combustion apparatus, it is possible to positively control and generate burnt, gas recirculation with a simple structure. Thus, the stability can be enhanced in a primary combustion zone, and effects of burnt gas recirculation can be maximized.

Since effects of burnt gas recirculation can be maximized with high stability, it is possible to perform combustion with a combustion gas having a high temperature and a low oxygen concentration to achieve pre-evaporation combustion having stable evaporation characteristics in a case of liquid fuel, in which it has been difficult to reduce NOx with the conventional technology, premixed combustion independent of gaseous fuel or liquid fuel, slow combustion, uniform combustion with a low maximum flame temperature, and combustion with a low average flame temperature due to the heat capacity of an inert gas in the combustion gas. Further, since a primary combustion zone can be designed so as to be leaner, it is possible to provide a gas turbine combustion apparatus which can suppress generation of thermal NOx by lowering a combustion temperature.

Furthermore, since an inner wall of the combustion apparatus is suitably cooled by an air flow having a low temperature, it is possible to provide a gas turbine combustion apparatus having a high durability.

Further, it is possible to provide a gas turbine combustion apparatus which can readily use a heat resistant material such as ceramics. Furthermore, since disassembly and replacement are facilitated, it is possible to provide a gas turbine combustion apparatus having easiness of maintenance.

Since a liner can be exposed while no air flows outside of the primary combustion zone, fuel nozzles and an ignition device can be disposed with a simple structure. Accordingly, it is possible to provide a gas turbine combustion apparatus which can reduce cost.

Since thermal expansion of the liner can be reduced with respect to the casing, the structure can be simplified. Accordingly, it is possible to provide a gas turbine combustion apparatus which can reduce cost.

When auxiliary fuel nozzles are provided, it is possible to provide a gas turbine combustion apparatus which can suppress generation of thermal NOx in multi fuel combustion of gaseous fuel/liquid fuel and combustion with fuel or a waste liquid having a low heating value.

The embodiments described above can be modified within the scope of the present invention. A technical extension of the present invention should be determined based on the description of claims. That is, the illustrated embodiments are described by way of example, and do not limit the scope of the present invention.

### INDUSTRIAL APPLICABILITY

The present invention is suitably used for a combustion apparatus for supplying combustion air and fuel to a combustion chamber to mix and combust the combustion air and the fuel.

1. A combustion apparatus comprising:
a cylindrical combustion chamber;
an air supply portion for supplying combustion air into said combustion chamber; and
a fuel supply portion for supplying fuel into said combustion chamber,
wherein a flow of the combustion air supplied into said combustion chamber first crosses a track of the fuel supplied into said combustion chamber at a region away from said fuel supply portion and then crosses the track of the supplied fuel again at a region near said fuel supply portion.

2. The combustion apparatus as recited in claim 1, wherein said fuel supply portion is configured so as to form a flow of the fuel with a velocity component in a direction of a central axis of said combustion chamber and a velocity component in a direction from the central axis of said combustion chamber to a wall surface of said combustion chamber
wherein said air supply portion is configured so as to form a flow of the combustion air with a velocity component in a direction opposed to the direction of the fuel with respect to the direction of the central axis of said combustion chamber and a velocity component to swirl in a circumferential direction.

3. The combustion apparatus as recited in claim 2, wherein the flow of the fuel has a velocity component in the direction of an outlet of said combustion apparatus,
wherein the flow of the combustion air has a velocity component in a direction opposite to the direction of the outlet.

4. A combustion apparatus comprising:
a cylindrical container having a close end and an open end;
an inflow passage for supplying combustion air into a combustion chamber in said cylindrical container, said inflow passage being formed at a location away from said close end in a direction of a central axis of said cylindrical container so as to extend through a side surface of said cylindrical container; and
a fuel nozzle provided inside of said close end of said cylindrical container for supplying fuel into said combustion chamber in said cylindrical container,
wherein said inflow passage is configured so as to form a flow of the air with a velocity component in the direction of the central axis of said cylindrical container from said open end to said close end and a velocity component to swirl in a circumferential direction of said cylindrical container,
wherein said fuel nozzle is configured so as to inject the fuel toward said inflow passage with a velocity component in the direction of the central axis of said cylindrical container from said close end to said open end and a velocity component directed radially outward.

5. A combustion apparatus comprising:
a cylindrical container having a close end and an open end;
an inflow passage for supplying combustion air into a combustion chamber in said cylindrical container; and
a fuel nozzle for supplying fuel into said combustion chamber in said cylindrical container,
wherein said cylindrical container has a portion having a reduced diameter at a location away from said close end along a central axis of said cylindrical container by a predetermined distance,
wherein said inflow passage is formed at said portion having a reduced diameter in said cylindrical container and is configured so as to form a flow of the air with a velocity component in the direction of the central axis of said cylindrical container from said open end to said close end and a velocity component to swirl in a circumferential direction of said cylindrical container,
wherein said fuel nozzle is configured so as to inject the fuel toward said inflow passage with a velocity component in the direction of the central axis of said cylindrical container from said close end to said open end and a velocity component directed radially outward.

6. A combustion apparatus comprising:
a cylindrical container having a close end and an open end;
a cylindrical member disposed substantially coaxially with a central axis of said cylindrical container and positioned on said open end side, said cylindrical member having a diameter smaller than that of said cylindrical container;
an annular connecting member connecting said open end of said cylindrical container and an outer circumferential surface of said cylindrical member to each other;
an inflow passage formed in said connecting member for supplying combustion air into said combustion chamber in said cylindrical container; and
a fuel nozzle provided inside of said close end of said cylindrical container for supplying fuel into said combustion chamber in said cylindrical container,
wherein said inflow passage is configured so as to form a flow of the air with a velocity component in the direction of the central axis of said cylindrical container from said open end to said close end and a velocity component to swirl in a circumferential direction of said cylindrical container,
wherein said fuel nozzle is configured so as to inject the fuel toward said inflow passage with a velocity component in the direction of the central axis of said cylindrical container from said close end to said open end and a velocity component directed radially outward.

7. The combustion apparatus as recited in claim 4, wherein a second inflow passage is provided on a side surface of said cylindrical container near said close end for supplying air inwardly in a radial direction of said cylindrical container.

8. The combustion apparatus as recited in claim 4, wherein a flow adjusting structure is provided on said close end within said cylindrical container and or on a side wall near said close end for suppressing a flow of the air swirling in a circumferential direction of said cylindrical container with a velocity component in the central axis of said cylindrical container from said open end to said close end in a region near said close end.

9. The combustion apparatus as recited in claim 4 wherein a flow adjusting structure is provided on said close end within said cylindrical container and/or on a side wall of said cylindrical container near said close end for converting a flow of air having a velocity component in a direction of the central axis of said cylindrical container from said open end to said close end and swirling in a circumferential direction of said cylindrical container into a flow directed inwardly in a radial direction near said close end.

10. The combustion apparatus as recited in claim 4, wherein an additional fuel nozzle is provided at a location closer to said close end than said inflow passage with respect to the direction of the central axis of said cylindrical container.

11. A combustion method of supplying combustion air and fuel into a combustion chamber in a combustion apparatus and mixing and combusting the combustion air and the fuel,
wherein a track of a air flow and a track of a fuel flow are not the same in said combustion chamber,
wherein the track of the air flow first crosses the track of the fuel flow at a region near a tip of the track of the fuel flow and then crosses the track of the fuel flow again at a region from a root of the track of the fuel flow to a vicinity of the tip.

12. The combustion method as recited in claim 11, wherein the fuel flow has a velocity component in a direction of a central axis of said combustion chamber and a velocity component in a direction from the central axis of said combustion chamber to a wall surface of said combustion chamber,
wherein the air flow has a velocity component in a direction opposed to the direction of the fuel with respect to the direction of the central axis of said combustion chamber and a velocity component to swirl in a circumferential direction.
